(19) United States
(12) Patent Application Publication
(10) Pub. No.: US 2009/0049447 A1
(43) Pub. Date: Feb. 19, 2009

(54) METHODS AND SYSTEMS FOR CARE READINESS

(76) Inventor: MICHAEL PARKER, Tuscaloosa, AL (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/191,744

(22) Filed: Aug. 14, 2008

Related U.S. Application Data
(60) Provisional application No. 60/955,713, filed on Aug. 14, 2007.

(51) Int. Cl. G06F 9/46

(52) U.S. Cl. 718/103

(57) ABSTRACT

Provided are methods and systems for generating a care plan. The methods, which can be implemented as a Parent Care Readiness Program (PCR-P), can use information and resources to improve caregiving readiness for imminent and active care givers. In an aspect, the Parent Care Readiness program can comprise two, complementary, automated, comprehensive, evidence-based assessments of the landscape of caregiving tasks, one from adult child's and one from parent's perspective, and a tailored intervention program that care givers and care receivers can discuss and implement.

### CROSS REFERENCE TO RELATED PATENT APPLICATIONS

This application claims priority to U.S. Provisional Application No. 60/955,713 filed Aug. 14, 2007 herein incorporated by reference in its entirety.

### BACKGROUND

Contrary to popular opinion, most Americans do not abandon older family members to nursing homes or paid professionals. Instead, most children devote substantial time and effort into fulfilling their filial responsibilities. Caring for an elderly parent is more challenging now because of the growth of our aging population, reductions in nuclear family size, increased female labor force participation, the growing isolation of primary caregiver (CGs), and other changes in family structure and stability. Ideally, adult children would be ready to implement carefully constructed parent care plans based upon the best information, in consultation with the parent and trusted geriatric professionals. However, most adult children are not prepared for this developmental task.

### SUMMARY

Provided are methods and systems for generating a care plan, comprising presenting a user with a plurality of domains, receiving a selection of one of the plurality of domains, presenting the user with a plurality of questions associated with the selected domain, receiving an answer to each of the plurality of questions, identifying, based on the received answers, a plurality of tasks and a priority associated with each of the plurality of tasks, and presenting a prioritized listing of identified tasks as a care plan to the user.

Also provided are methods and systems for generating a care plan, comprising retrieving a previously generated care plan having a prioritized task, presenting the previously generated care plan to a user, querying the user as to a completion status of the prioritized task, receiving a response to the query, and updating the previously generated care plan according to the response.

Additional advantages will be set forth in part in the description which follows or may be learned by practice. The advantages will be realized and attained by means of the elements and combinations particularly pointed out in the appended claims. It is to be understood that both the foregoing general description and the following detailed description are examples of embodiments and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 illustrates a model of successful care giving;

FIG. 3 is a flowchart illustrating an exemplary scoring method;

FIG. 4 is a flowchart illustrating an exemplary method for generating a care plan;

FIG. 5 is another flowchart illustrating an exemplary method for generating a care plan;

FIG. 6 is a flowchart illustrating an exemplary method for generating a care plan; and

FIG. 7 is exemplary website structure for implementing the methods.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The methods are disclosed herein in the context of a parent care readiness plan. However, the methods can be used for other forms of care giving (E.g., acquired traumatic and non traumatic spinal cord injured people and their caregivers; developmentally disabled people—mentally or physically disabled and their caregivers; cancer patients and their caregivers; and the like). Furthermore, the methods and systems are described as being utilized by a user or a CG. A user or a CG can be a person providing care. However, it is contemplated that a person receiving care can also utilize the methods and systems provided.

The family caregiving experience has been consistently described as a time of transition: a transition from the role of child to a new and often unfamiliar relationship with a parent. This transition from the familiar to the unexpected relationship is thought to begin the caregiving career. Unlike the traditional work career, the caregiving career is unplanned, unexpected and not always wanted. Typically, family members are not prepared for the burden of care associated with chronic conditions like Alzheimer's disease; rather, family CGs often find themselves simply reacting to a series of crises rather than making informed proactive choices related to critically important caregiving tasks. Generally, Alzheimer Disease interventions have produced small to moderate effects on key clinical outcomes such as depression and burden. Close inspection of findings suggest that interventions are most effective when they target specific outcome variables (e.g., burden related to problem behaviors) with a high dose of treatment specifically designed to address the CG's need. Parental caregiving is best approached proactively as a normal, developmental responsibility, and not as a burden.

Many barriers exist to quality caregiving. The methods and systems provided overcome those barriers. For example, a “getting started” barrier exists. Currently there is no simple process for accessing resources and services and developing a comprehensive plan that encourages the completion of high priority tasks. Most CGs do not know where or how to begin the process. Additionally, leaving important tasks unattended or incomplete can result in CG burden and depression, inadequate health care for the parent, family conflict, financial exploitation, or unintentional dissipation of assets. However, the majority of imminent and active CGs fail to act proactively in accomplishing the “tasks” of caregiving because most wait until a health care crisis or event before taking action.

A barrier to quality care giving is an adequate understanding of how to access and utilize gerontologists representing different professional disciplines, specialties and subspecialties. These professionals provide state of science and practice information needed by the CG and his/her care recipient (CR). The methods and systems provided help CGs and their care recipients learn about how to utilize and to access these professionals on a local, state, and national level. Geriatricians, elder law attorneys, geriatric trained nurses, psychologists, social workers, physical and occupational therapists, and geriatric care managers, are some of professional and para professional groups often needed by CGs. The methods and systems provided reinforce the importance of securing “team care” for a parent. The tasks of parent care are often complex, time consuming and should involve the services of a variety of geriatric professionals, yet interdisciplinary professional counsel regarding parent care is not readily available in many communities. Shortages of particular professional groups (e.g., geriatricians, elder law attorneys) constitute an additional impediment to quality care giving. Further, beginning the process of accessing professional geriatric support is intimidating for many CGs, particularly given today's complex health care system. These challenges can interact with the “getting started” challenge discussed previously, further compounding the tendency of many adult children to miss the opportunity to approach caregiving in a proactive manner.

Yet another barrier to quality caregiving is information overload. The Internet provides an excellent resource for overcoming the information access problems of active and future CGs. However, although an extensive array of resources exist to help CGs, many experience what might be described as an “information overload” as they attempt to sort through and select high quality resources appropriate to their situations. Unfortunately, the proliferation of web sites also constitutes a major problem. A recent web search using the term “caregiving” with a major search engine resulted in over 11,400,000 hits. Perhaps most importantly, much of the caregiving information on the Internet and in lay-oriented books has not been subjected to scientific scrutiny, and some sites are of dubious reliability and value. In sum, the Internet represents a wealth of easily-accessed information for active and would be CGs, yet the sheer magnitude of this information, coupled with the need to critically evaluate these resources represents a significant barrier to the use of Internet caregiving information.

Another barrier to quality caregiving is distance caregiving. Maintaining contact with elderly parents and providing care for them from a long distance represent major challenges for a burgeoning number of families in the United States. According to the National Council on Aging (NCOA), approximately seven million family members currently provide long-distance care, and the NCOA estimates that these numbers will double in 15 years. A recent study indicates that nearly half of all long-distance CGs spend time arranging for needed services or checking that care is being received, and almost three-quarters spend time managing finances or providing or arranging for help with other instrumental activities of daily living such as managing medications, transportation, cooking or house cleaning.

The present methods and systems may be understood more readily by reference to the following detailed description of preferred embodiments and the Examples included therein and to the Figures and their previous and following description.

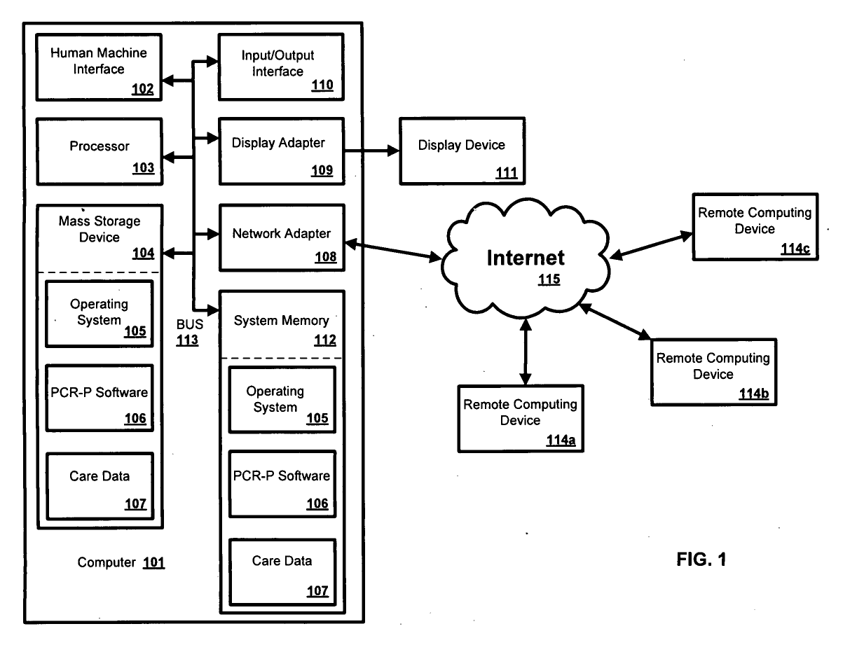

One skilled in the art will appreciate that provided is a functional description and that the respective functions can be performed by software, hardware, or a combination of software and hardware. FIG. 1 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 113, and all buses specified in this description can also be implemented over a wired or wireless network connection and each of the subsystems, including the processor 103, a mass storage device 104, an operating system 105, PCR-P software 106, care data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as care data 107 and/or program modules such as operating system 105 and PCR-P software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and PCR-P software 106. Each of the operating system 105 and PCR-P software 106 (or some combination thereof) can comprise elements of the programming and the PCR-P software 106. Care data 107 can also be stored on the mass storage device 104. Care data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems. Examples of care data 107 include, but are not limited to, literature pertaining to various caregiving fields, contact information for experts in various caregiving fields (e.g., elder law attorneys, geriatricians, geriatric care managers), and state of science and practice information about successful aging, late life driving, dementia, and living with chronic disease and disability.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of PCR-P software 106 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The methods, which can be implemented as a Parent Care Readiness Program (PCR-P), can use information and resources to improve caregiving readiness for imminent and active CGs. In an aspect, the Parent Care Readiness program can comprise two, complementary, automated, comprehensive, evidence-based assessments of the landscape of caregiving tasks, one from adult child's and one from parent's perspective, and a tailored intervention program that CGs and CRs can discuss and implement. The methods can comprise an automated, comprehensive, evidence-based assessment of the spectrum of caregiving tasks. The methods can further comprise a tailored intervention program, also referred to as a care plan, that adult children can implement. The tailored intervention program can comprise information packages with state-of-science and practice recommendations (managing complex insurance claims) and/or can assist CGs and the care recipient(s) in connecting with local professionals in preparing for specific tasks associated with elder care giving (e.g., completion of geriatric assessment).

The PCR-P is grounded in a life course perspective, which emphasizes the ways in which people's location in the social system, the historical period in which they live, and their unique personal biographies shape their experiences. This overarching framework provides a positive and powerful perspective for addressing cultural, developmental and demographic changes that influence family and work, like the growing challenge of taking care of parents who are living longer. It affords adult children with a much needed way of conceptualizing parental caregiving as a normal, developmental stage of life that requires preparation in order to receive the many positives associated with successful caregiving. It also carries with it the implication that prepared CGs may be more successful in avoiding some of the negative consequences of caregiving. Finally, a life course perspective promotes a broader, more accurate view of how extensive the issue of parental caregiving is in the U.S.

In an aspect, an interdisciplinary team of experts in the field of aging, for example, can be utilized to review, critique, and revise the content of the PCR-P to ensure the state of science and practice quality of the information provided. Each expert can be selected on the basis of his/her training, expertise in care giving, record of publications and scientific funding, and his/her commitment to the translation of state-of-science gerontological research and practice.

In an aspect, the PCR-P can comprise two components. The first component can be referred to as a Parent Care Readiness Assessment (PCR-A). The PCR-A can be a computerized, scored evaluation that helps CGs assess their level of preparedness for caregiving. The computerized scoring algorithm for the PCR-A is based upon adaptations of the Trans-theoretical Model of Change and other pedagogic models. It can review a range of possible caregiving tasks, and help the imminent and/or active CG prioritize those tasks considered most important to them. The PCR-A can provide ratings of importance and degree of completion for parent care tasks. The parent care tasks can be divided into a plurality of domains. For example, the parent care tasks can be divided into four domains: legal-insurance-financial, medical, family-social, and spiritual-emotional.

Another component of the PCR-P can be referred to as a Parent Care Readiness-Intervention (PCR-I), also referred to as a care plan. The PCR-I can comprise a series of computerized, information packages that comprise state-of-science and practice recommendations and related local, state and national resources (or combinations thereof) specific to the caregiving priorities of the end-user, as identified through the PCR-A the user has completed.

The methods and systems provided address the aforementioned barriers to quality caregiving. The PCR-P addresses the “Getting Started” barrier by providing a structured program that gets the CG started with an assessment that helps them think about the overall issues that could be relevant one day. It helps CGs prioritize a manageable number of tasks on which to get started (successful completion of which will reinforce the CG to continue to act proactively), and then provides the adult child with the convenience of immediate informational packets that guide the CG in what to do next. The professional laden nature of the program encourages consultation and seeks to translate state-of-science information for specific tasks. The PCR-P can allow a CG to start an assessment and complete the process at a later date without loss of information. The PCR-P encourages early and thoughtful parent care planning so as to minimize future barriers to quality care (e.g., onset of dementia coupled with lack of durable power of attorney for decision-making).

The PCR-P addresses the information access and information overload barriers by using the Internet as a conduit to provide information access to the CG, while at the same time, the PRC-A and PCR-I tailors the resources, and prioritizes and limits the number of caregiving tasks addressed at one time. Task specific recommendation packages can be reviewed for state-of-science and practice quality by geriatric experts to assure the quality of the information provided. For example, a PCR-I can comprise national and local/state links to high quality, state-of-science websites, professionals, and programs that offer reliable, detailed information and sources of support and professional assistance. In choosing informational sites to recommend to CGs, the PCR-P can utilize, for example, Setting Priorities for Retirement Years (SPRY) Foundation and National Institute on Aging (NIA) criteria which are herein incorporated by reference in their entirety (e.g., Can you tell who created the content? Are you given enough information to judge if the author is reliable? Can you tell if the content is current?). Finally, the PCR-P represents a tool that can be used by distant as well as proximate CGs because it links active and future CGs to geographically relevant resources, websites, and geriatric professionals in the community and state where their care recipients live.

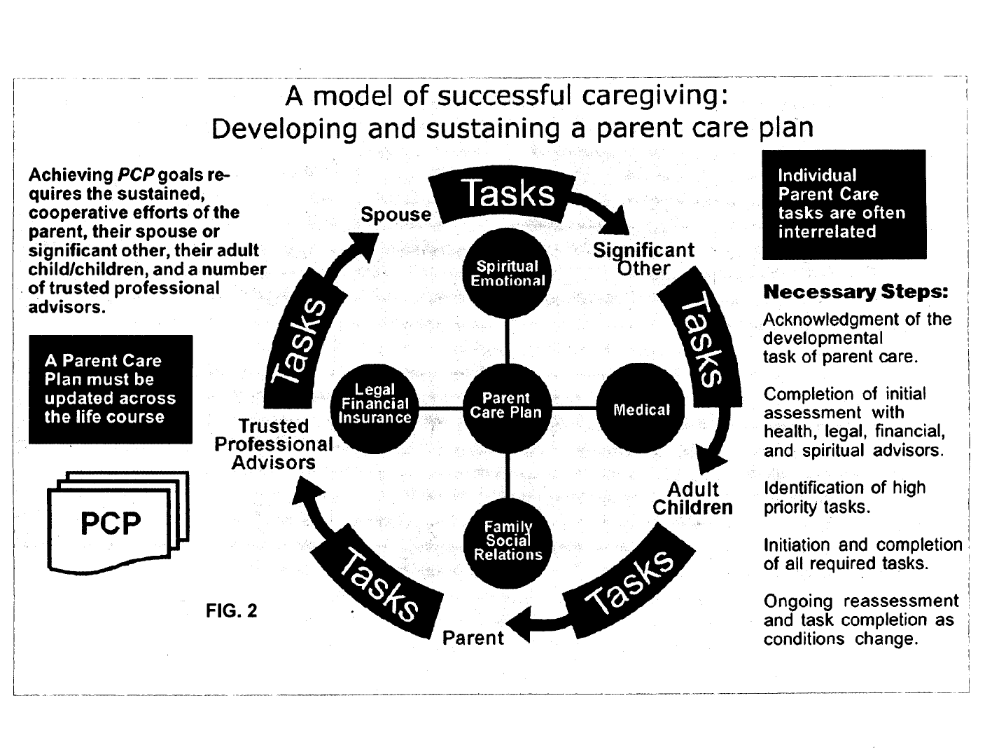

Grounded in the life course perspective, the PCR-P Model of Caregiving is illustrated in FIG. 2. The model emphasizes the importance of including family, friends, and a broad range of geriatric professionals who can help the primary CG respond to the dynamic and unpredictable nature of care giving (e.g., onset of vascular dementia following a stroke). The model seeks to prevent the isolation of the primary CG, which can lead to CG burnout and substandard care for the care recipient. From a life course perspective, elder care giving occurs somewhat predictably in mid-life; therefore, it can be anticipated proactively. The PCR-P Model helps to normalize, rather than pathologize, elder care giving. Further, the PCR-P model portrays four domains of care giving tasks, each of which helps the CG prepare conceptually for specific tasks of care giving by organizing or simplifying the complex array of tasks. For example, CGs are directed under the medical domain to medical clinics that provide drivers assessment programs; which, in turn, have the capacity to assess and correct sensory impairments that limit elders' abilities to drive safely. Finally, the PCR-model emphasizes the unfolding quality of care giving that may require the completion of additional tasks as needs arise.

The model emphasizes that caring for a parent or elder represents a positive, normal, age-graded (midlife), developmental responsibility that requires preparation. When CGs are prepared for tasks, they are more likely to experience the positive aspects of caregiving such as the development of closer kinship ties. Further, early and thoughtful parent care planning can minimize future barriers to task completion (e.g., onset of dementia). The development of a caregiving plan can be a dynamic, ongoing process that involves the initial assessment of the landscape of possible tasks, and the completion of specific tasks, followed by a reappraisal process as circumstances change. The model guides this process through its emphasis on priority-setting guided by the person's motivation and readiness to act. This pedagogical approach, grounded in a life course perspective, views caregiving as a normal part of life, which provides the social context for learning about caregiving. The PCR-P accentuates the importance of active learning strategies that underscore the importance of repeating main ideas in an orderly sequence to enhance learning. The automated features of the program enable a user to develop his/her own strategy of completing the assessment and taking action on the recommendations. For example, a user is able to work at the user's own pace and schedule, a feature that can be critically important for “older” learners. Finally, the program capitalizes on intrinsic forms of motivation associated with the positive outcomes of caregiving.

Utilization of specific caregiving information, when guided by a proper assessment tailored to a specific family and parent, can enhance the confidence of CGs, reduce CG burden and associated work-related spillover, and favorably influence the quality of life and care aging parents receive. The model for developing and sustaining a comprehensive Parent Care Plan (PCP), illustrated in FIG. 2, was developed on these observations. Core to the PCP intervention model is the development of a long-term care plan which involves the proactive completion of specific tasks viewed as important and relevant to elderly parents, their family, and geriatric consultants of different disciplines.

The model is based on a dynamic process that can comprise the completion of specific tasks. The model can also comprise a continuous reassessment and appraisal as circumstances change. The tasks of parent care can be divided into domains as shown in FIG. 2. Each domain can reflect a real life challenge that potentially comprises an important aspect of a parent's long term care plan. The model underscores the importance of assessment in all four domains, and the necessity of a tailored intervention that provides assistance for designated, high priority tasks. The process of generating a tailored intervention minimizes the “smorgasbord” approach because only critical information and resources are provided. This is strategically important because many adult children entering a caregiving trajectory are not motivated to complete necessary tasks because their parents are relatively healthy or because they are disengaged for other reasons.

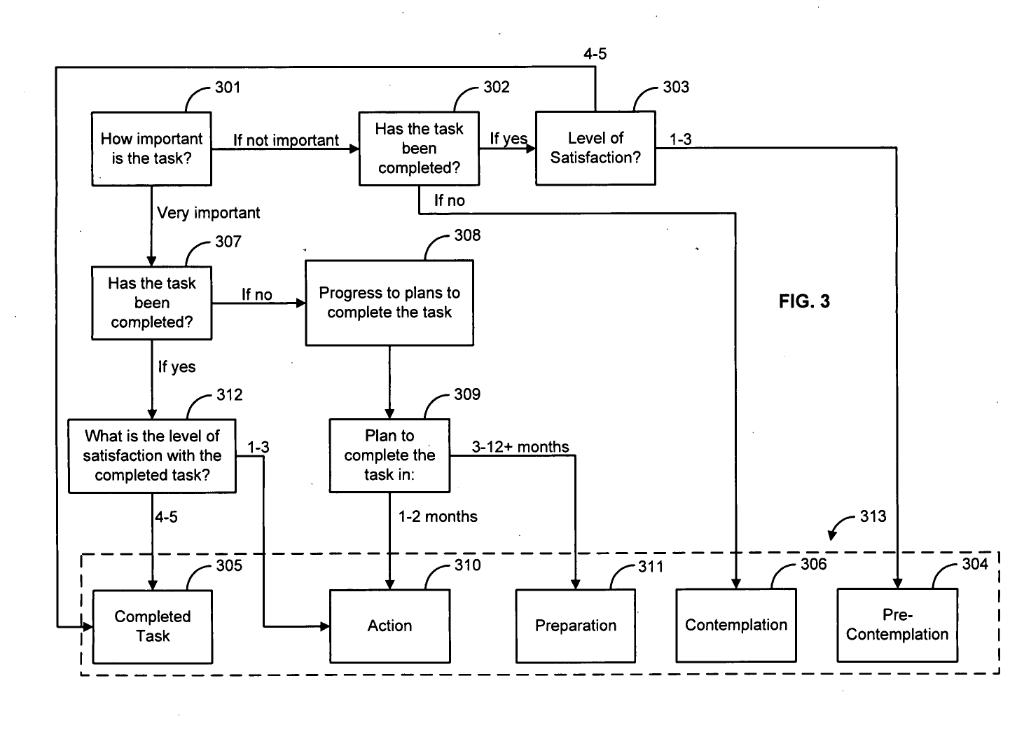

The PCR-P accentuates the importance of active learning strategies that underscore the importance of repeating main ideas in an orderly sequence to enhance learning. The automated features of the program enable a user to develop his/her own strategy of completing the assessment and taking action on the recommendations. For example, a user is able to work at his own pace and schedule, a feature that is critically important for “older” learners. The PCR-P capitalizes on intrinsic forms of motivation associated with the positive outcomes of care giving (helping adult children “honor” their parent, achieve mastery of care giving tasks, become successful CG s). The PCR-I, or tailored intervention, can comprise the completion of prioritized tasks. The prioritization process can be achieved, for example, by using the scoring algorithms illustrated in FIG. 3. In part, the range of scoring options generates outcomes sensitized to the respondent's readiness to change (i.e., completing a specific task related to care giving). Options range on the horizontal axis in FIG. 3 from “not thinking about changing” (Pre-contemplation) to “thinking about change” (contemplation) to “intending to change” (preparation) to “attempting a change” (action) to “sustaining a change” (task completion). Precontemplation is the stage at which there is no intention to change behavior in the foreseeable future. Many individuals in this stage are unaware or underaware of their problems. Contemplation is the stage in which people are aware that a problem exists and are seriously thinking about overcoming it but have not yet made a commitment to take action. Preparation is a stage that combines intention and behavioral criteria. Individuals in this stage are intending to take action in the next month and have unsuccessfully taken action in the past year. Action is the stage in which individuals modify their behavior, experiences, or environment in order to overcome their problems. Action involves the most overt behavioral changes and requires considerable commitment of time and energy.

Completed tasks become part of the CG's parent care plan. In summary, the PCR-A can use a set of questions that determine the “level of change” status of a respondent before providing information. This process helps prevent information overload by providing tailored feedback that is matched to the respondent's “change status” on a particular task.

For example, illustrated in FIG. 3, the importance of a task can be determined at block 301. If the task is not important, it can be determined if the task has been completed at block 302. If the task has been completed, the level of satisfaction with the completed task can be determined at block 303. The level of satisfaction can be determined, for example, by querying a user for the level of satisfaction. The response from a user can be a selection from a range of values. For example, a range from one to five. One can indicated low satisfaction and five can represent high satisfaction. The value in between represent a sliding scale of satisfaction between low and high. If the level of satisfaction is low (for example, receives a score from 1-3 out of 5), then the task can be identified as a pre-contemplation stage of change task at block 304. If, at block 303, the level of satisfaction is high (for example, receives a score from 4-5 out of 5), then the task can be identified as a completed task at block 305. If, at block 302, the task has not been completed, the task can be identified as a contemplation stage of change task at block 306.

If at block 301, it is determined that the task is very important, it can be determined if the task has been completed at block 307. If the task has not been completed, the user can progress to make plans to compete the task at block 308. At block 309, the timing within which to complete the task can be determined. If the timing is below a predetermined threshold, such as three months, the task can be identified as an action stage of change task at block 310. If the timing is at or above a predetermined threshold, such as three months, the task can be identified as a preparation stage of change task at block 311.

If at block 307, it is determined that the task has been completed, the level of satisfaction can be determined at block 312. If the level of satisfaction is low (for example, receives a score from 1-3 out of 5), then the task can be identified as an action stage of change task at block 310. If, at block 312, the level of satisfaction is high (for example, receives a score from 4-5 out of 5), then the task can be identified as a completed task at block 305.

The system can interact with a calendaring component to provide deadlines/goals for task completion. The calendaring component can be built into the system and/or can be external to the system (such as Microsoft Outlook).

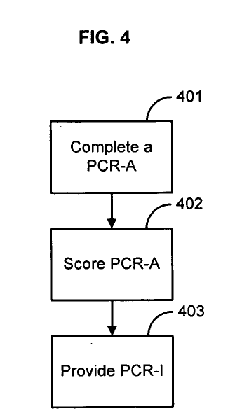

An exemplary PCR-P planning process is illustrated in FIG. 4. At block 401, a CG can complete a PCR-A. An exemplary PCR-A is provided below. PCR-As can be constructed in keeping with the tenets of the Trans Theoretical Model of Change (TMC). The TMC postulates that in order to progress through the stages toward successful change, individuals at different stages need to engage in different, stage-relevant processes of change. Thus, the focus is on the process of change, as well as outcome. Adapting TMC constructs to address willingness to learn more about parent care activities provides a solid and well established foundation for intervention development and delivery flowing from the assessment. Thus, a CG can review his or her state of readiness in four domains of tasks. Active and imminent CGs can provide their sense of priority regarding each of 50 tasks, and identify those tasks that have been completed, but in a less than satisfactory manner. The methods and systems can score the PCR-A at block 402 and identify those tasks that need to be completed, and provide a sense of when these tasks should be completed. The PCR-P provides CGs and care recipient(s) with tailored outcomes based on the assessment process that addresses unique needs and proclivities.

After completion of the PCR-A, a CG can be provided with information packages from a PCR-I at block 403. The tasks that make up the PCR-A can have corresponding PCR-I information packages including, but not limited to, state-of-science and practice recommendations, local/state resources, and national resources pertinent to the task. These information packages can be retrieved from a directory or database that has been developed and curated by experts in various fields of care giving. NIA and SPRY foundation criteria can be used to assess the value and reliability of resources used in the information packages.

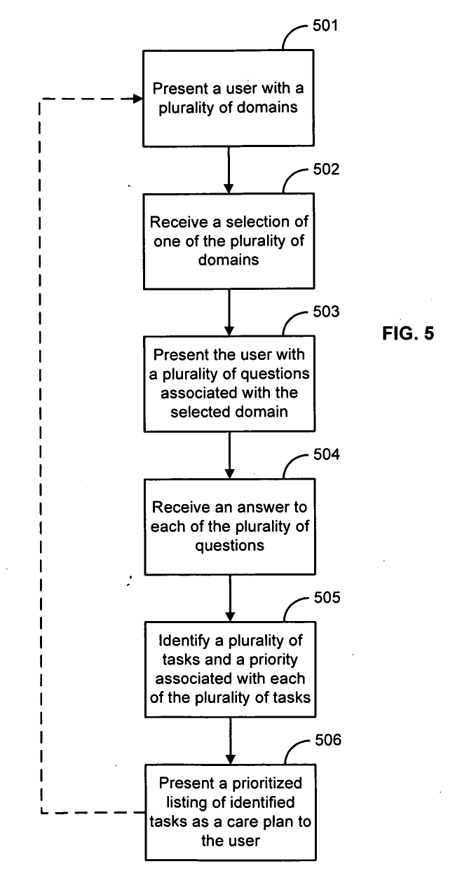

In one aspect, illustrated in FIG. 5, provided are methods for generating a care plan, comprising presenting a user with a plurality of domains at block 501, receiving a selection of one of the plurality of domains at block 502, presenting the user with a plurality of questions associated with the selected domain at block 503, receiving an answer to each of the plurality of questions at block 504, identifying, based on the received answers, a plurality of tasks and a priority associated with each of the plurality of tasks at block 505, and presenting a prioritized listing of identified tasks as a care plan to the user at block 506.

The plurality of domains can represent a range of caregiving tasks. For example, the care giving tasks identified in the PCR-A provided below. For example, the plurality of domains can comprise at least one of a spiritual/emotional domain, a medical domain, a family/social relations domain, and a legal/financial/insurance domain.

The user can develop answers based on consultation with a domain advisor. Domain advisors can include, but are not limited to, medical doctors, clergy, public health professionals, professors, attorneys, elected officials, social workers, and the like.

The step of identifying, based on the received answers, a plurality of tasks and a priority associated with each of the plurality of tasks can comprise determining if a task is important to the user, determining if the task has been completed, determining a level of user satisfaction with the completed task, and prioritizing the task according to a stage of change based on the importance to the user, the completion of the task, and the level of user satisfaction with the completed task.

If the task is important to the user, if the task has been completed, and if the task has been completed to the satisfaction of the user, the task can be identified as a completed task stage of change.

If the task is important to the user, if the task has been completed, and if the task has not been completed to the satisfaction of the user, the task can be identified as an action stage of change task.

If the task is not important to the user, if the task has been completed, and if the task has not been completed to the satisfaction of the user, the task can be identified as a pre-contemplation stage of change task.

If the task is not important to the user, if the task has been completed, and if the task has been completed to the satisfaction of the user, the task can be identified as a completed task stage of change.

If the task is not important to the user, if the task has been completed, and if the task has not been completed to the satisfaction of the user, the task can be identified as a contemplation stage of change task.

The step of identifying, based on the received answers, a plurality of tasks and a priority associated with each of the plurality of tasks can comprise determining if a task is important to the user, determining if the task has been completed, and determining a timeframe in which to complete the task. If the task is important to the user and if the task has not been completed, the task is identified as an action stage of change task if the timeframe is less than a predetermined amount or the task is identified as a preparation stage of change if the timeframe is equal to or greater than the predetermined amount.

The step of identifying, based on the received answers, a plurality of tasks and a priority associated with each of the plurality of tasks can comprise determining if a task is important to the user and determining if the task has been completed, wherein if the task is not important to the user and has not been completed, the task can be identified as a task upon which to contemplate stage of change.

The methods can further comprise providing information packages to the user based on the care plan. The methods can further comprise presenting a suggested action to complete at least one of the plurality of identified tasks.

The methods can further comprise repeating blocks 501-506 when a life condition changes. The life condition can comprise, for example, onset of Alzheimer's disease, stroke leading to vascular dementia, severe osteoporosis, incontinence, a terminal diagnosis and condition, death of a spouse, and the like.

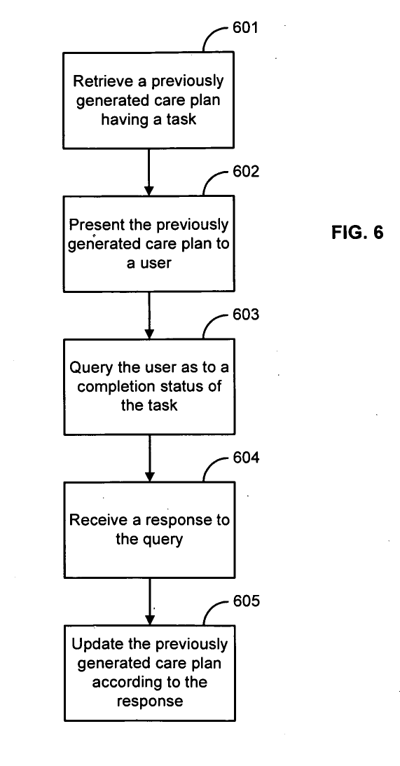

In another aspect, illustrated in FIG. 6, provided are methods for generating a care plan comprising retrieving a previously generated care plan having a prioritized task at block 601, presenting the previously generated care plan to a user at block 602, querying the user as to a completion status of the prioritized task at block 603, receiving a response to the query at block 604, and updating the previously generated care plan according to the response at block 605.

The previously generated care plan can represent a prioritized task identified based on responses to queries presented to the user associated with a domain and identifying, based on the responses, a prioritized task. The domain can be, for example, at least one of a spiritual/emotional domain, a medical domain, a family/social relations domain, and a legal/financial/insurance domain. The methods can further comprise providing information packages to the user based on the care plan. The methods can further comprise presenting a suggested action to complete at least one of the plurality of identified tasks.

In the following example, a 40-year old, employed distant CG (daughter) from Mobile, Ala., lives outside of a 50-mile radius from her widowed mother (or over 1-hour drive), who resides in Birmingham, Ala. The CG is worried about her mother who lives alone in Birmingham. Exemplary information packages can comprise contact information (websites, telephone #s, and addresses) that provide local geriatrics, geriatric care managers, approved CGs, and gerontologists who might be of assistance to the distant daughter and her mother.

The following is an example of an abbreviated tailored intervention based off of a task in the family domain:

“Discuss with your parent(s) the possibility that at some point it may be unwise for him/her to continue driving and ask how your parent(s) would like you to take action if you perceive he or she should no longer drive. Identify local or regional driver education programs for seniors (AAA, AARP) that can reduce the costs of auto insurance when completed and identify medical driver education and evaluation programs.”

In this example, the CG rated this task as very important, and though the CG attempted to complete the task, the CG was not satisfied with the outcome. In addition, the CG indicated that completion of this task has the highest priority because the CG wants to take action in the next 30-days. For these reasons, this task that needs immediate attention.

PCR-I “abbreviated” tailored intervention:

“The keys to reducing accidents and unsafe driving are for older adults and their family members to recognize signs of unsafe driving, intervene appropriately, and find alternative means of transportation before safety becomes an issue. Please review the local and national sites and resources provided below. It is strongly recommend that you discuss the matter with your parent, and that you consider making an appointment as soon as possible with the University of Alabama at Birmingham (UAB) Driving Assessment Clinic. If your parent provides permission, you may want to discuss the driving issue with your parent's physician. It is not necessary to have a physician's referral in order to schedule an appointment. When you ‘click on’ the UAB Driving assessment clinic site, you can find answers to most of your questions. In many cases, physicians are reluctant to refer their patients for a driver's assessment. In part, this is why geriatric experts have listed this as a ‘Family Task.’

### National Resources:

### AARP 55 Alive Driver Safety Program

(http://www.aarp.org/families/driver-safety/)

### U.S. Department of Transportation National Highway Traffic Safety Administration “Driving Safely While Aging Gracefully”

(http://www.nhtsa.dot.gov/people/injury/olddrive/Driving%20Safely%20Aging%20Web/) Local Resources:

### UAB Department of Opthalmology Driving Assessment Clinic UAB

Department of Opthalmology (http://www.eyes.uab.edu/driving/)

### Alabama Dementia Education and Training Program: Call 1 800 457-5679”

In another example, a task can be to develop strategies and procedures that would help minimize the risks to a parent for a variety of natural (severe weather, hurricanes, tornadoes, heat & cold waves) and human-caused disasters (Nursing homes without proper evacuation procedures). When a parent lives near the Gulf Coast, the PCR-P can alert adult children to the importance of this task, even if they do not identify it as an important task, by using the geographic location data entered on the PCR-A. Other areas of the country are of course at risk for other forms of severe weather (tornadoes>Midwest). These plans can be approved for feasibility by local experts and authorities (e.g., Sheriff, Homeland security, etc.). CGs can be made familiar with the response-plans of nursing homes, assisted living and retirement facilities to a broad range of possible life threatening events and circumstances where their parents reside.

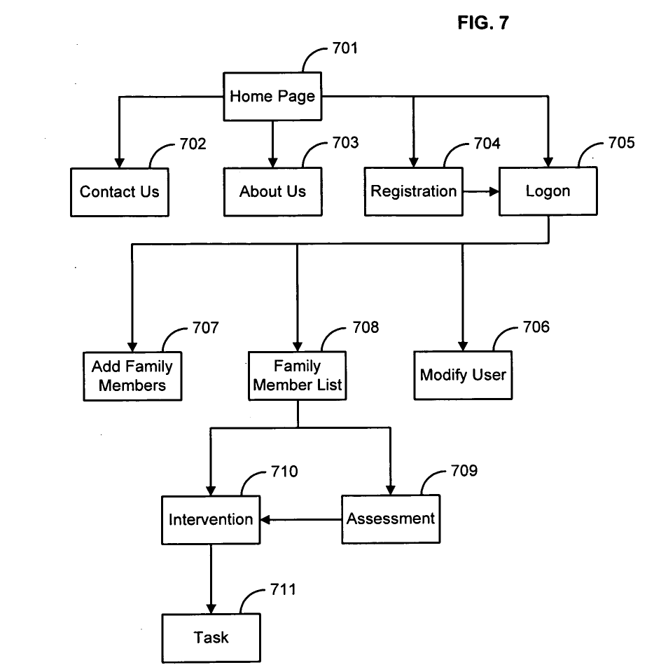

In one aspect, the PCR-P can be a web-based, computerized assessment that leads to a tailored, state-of-science intervention. An exemplary website structure for implementing the methods provided is illustrated in FIG. 7. A “Home” webpage 701 can provide access to a “Contact Us” webpage 702, an “About Us” webpage 703, a “Registration” webpage 704, and a “Logon” webpage 705.

The “Registration” webpage 704 can ask a user to create a user name, password, security question, and request an email address. For example, user credentials and authentication can be handled by ASP.NET membership provider which can store data in a Microsoft SQL 2005 server. The system can ensure that the user name is unique to the system.

The “Logon” 705 page can ask the user to enter their user name and password. When the user successfully logs on to the system they can be directed to, for example, the family member list page. Once a user is logged on to the system a navigation bar can be provided that provides, for example, a link to add family members, modify user information with the “Modify User” webpage 706, and log off the system.

An “Add Family Member” webpage 707 can be used to add data regarding family members to the system. A “Family Member List” webpage 708 can provided a list of currently added family members wherein the user can select a family member and view details regarding that family member. The “Family Member List” webpage 708 can list family members that the user can register with the system. When the user selects the name of the family member from the list the system can determine if an assessment has been completed. If the assessment has not been completed the user can be directed to an “Assessment” webpage 709 or, if the assessment has been completed, to an “Intervention” webpage 710.

The “Assessment” webpage 709 can display, for example, four domains (e.g., Medical, Legal, Family, and Spiritual) and display whether or not the assessment for each domain has been completed. If a domain assessment has not completed the user has the option of entering the domain. The user can be provided with a set of domain-specific instructions and a button to start the assessment. Each assessment question can require a valid answer before proceeding to the next question. A restriction can be used to prevent the user from answering questions out of order. If at any time during the assessment the user exits, the system can keep track of the user's progress and return the user to the question that was not completed for that specific domain upon return. Sub-questions can be dynamically displayed based on the user's response to an earlier question. This helps to shorten the number of questions displayed on the page. This also reduces the number of decisions that the user would need to make during the assessment, in turn reducing the burden on the user. When finished with a set of questions from the domain, the user can be returned to the assessment page. If all domains are completed the user can be directed to the “Intervention” webpage 710. The responses to the questions can be scored according to the scoring algorithm and stored in the database. If the scoring algorithm identifies more than a predetermined number of tasks as highest priority (for example, 7), the user can be asked to reevaluate the assessment to reduce the number of tasks to a more manageable number.

The “Intervention” webpage 710 can be organized into the same domains as the “Assessment” webpage 709. Each domain can, for example, display the number of tasks in the four categories that are ranked by the user's status of change status for each of the tasks within a specific domain as ranked by the algorithm scoring. The user can click on a domain and the task(s) can be displayed from that domain. The user can re-order tasks within a category in order to help track which task is of more importance at the time. The “Intervention” webpage 710 can have a link to modify the category of a specific task if the user has completed a task or determines that the preference of the task has changed over time. The user can select any of the task(s) and be directed to a webpage specific to that task.

A “Task” webpage 711 can provide detailed information packages that can assist the user in understanding and completing the task. The “Task” webpage 711 can provide links to other websites that are specific to the user or the family member geographic location for that task. Also links at the state and federal level can be provided. Worksheets and checklists can be provided that can be printed and used to complete the task if applicable. The user can maintain and update assessments for a plurality of family members, thus permitting an individual assessment of each parent and each in-law together with individually tailored information packages for each of the four older adults.

### III. Exemplary PCR-A Questions

PARENT CARE READINESS ASSESSMENT - Parent Version

| | | | | |
|---|---|---|---|---|
| 1. Schedule a | Level of Importance | Completed | Level of | If No, when |
| comprehensive | (1-2-3-4-5) | Yes/No | Satisfaction | do you plan |
| geriatric | N/A | | (1-2-3-4-5) | to complete |
| assessment with a | | | | the task? |
| certified geriatric | | | | 1-3-6-9- |
| physician (family | | | | 12+ |
| practice or an | | | | Months or |
| internist), who | | | | Never |
| specializes in the | | | | N/A |
| care of older | | | | |
| adults and who | | | | |
| can serve as either | | | | |
| your primary care | | | | |
| doctor or as a | | | | |
| consultant to your | | | | |
| primary care | | | | |
| physician. If you | | | | |
| are experiencing | | | | |
| dementia or late | | | | |
| life mental health | | | | |
| problems, or are | | | | |
| already located in | | | | |
| a Nursing Home, | | | | |
| you may want to | | | | |
| include a | | | | |
| psychiatrist | | | | |
| certified in | | | | |
| geriatrics. | | | | |
| 2. Find out what | Level of | Completed | Level of | If No, when |
| your current | Importance | Yes/No | Satisfaction | do you plan |
| medical conditions | (1-2-3-4-5) | | (1-2-3-4-5) | to complete |
| (diagnoses) are | N/A | | | the task? |
| and learn more | | | | 1-3-6-9- |
| about these | | | | 12+ |
| conditions, so that | | | | Months or |
| you can monitor | | | | Never |
| your health status | | | | N/A |
| and enhance the | | | | |
| quality of care you receive. | | | | |
| 3. Understand | Level of | Completed | Level of | If No, when |
| your current | Importance | Yes/No | Satisfaction | do you plan |
| functional status | (1-2-3-4-5) | | (1-2-3-4-5) | to complete |
| (life skills | N/A | | | the task? |
| necessary to live | | | | 1-3-6-9- |
| independently) | | | | 12+ |
| and how to | | | | Months or |
| monitor and | | | | Never |
| respond to | | | | N/A |
| changes in that | | | | |
| status, along with | | | | |
| other health | | | | |
| changes. | | | | |
| 4. Learn how to | Level of | Completed | Level of | If No, when |
| become an active | Importance | Yes/No | Satisfaction | do you plan |
| member of your | (1-2-3-4-5) | | (1-2-3-4-5) | to complete |
| care team by | N/A | | | the task? |
| maximizing your | | | | 1-3-6-9- |
| medical | | | | 12+ |
| compliance to | | | | Months or |
| appropriate | | | | Never |
| treatment plans; | | | | N/A |
| learn how to | | | | |
| question and | | | | |
| clarify specific | | | | |
| aspects of the | | | | |
| medical care | | | | |
| recommended. | | | | |
| 5. Develop a | Level of | Completed | Level of | If No, when |
| strategy for | Importance | Yes/No | Satisfaction | do you plan |
| keeping track of | (1-2-3-4-5) | | (1-2-3-4-5) | to complete |
| all prescriptions, | N/A | | | the task? |
| medications, and | | | | 1-3-6-9- |
| over- the- counter | | | | 12+ |
| medicines you | | | | Months or |
| take and have | | | | Never |
| access to; be sure | | | | N/A |
| you are on only | | | | |
| those medications | | | | |
| you need to be on, | | | | |
| and not to be on | | | | |
| any over the | | | | |
| counter or | | | | |
| prescriptions that | | | | |
| you do not need to | | | | |
| be on; and develop | | | | |
| with your children | | | | |
| a specific plan to | | | | |
| address you | | | | |
| medication needs | | | | |
| in an emergency | | | | |
| requiring your | | | | |
| evacuation. | | | | |
| 6. Schedule an | Level of | Completed | Level of | If No, when |
| appointment with | Importance | Yes/No | Satisfaction | do you plan |
| local geriatric care | (1-2-3-4-5) | | (1-2-3-4-5) | to complete |
| manager(s) to | N/A | | | the task? |
| develop, review | | | | 1-3-6-9- |
| and enhance your | | | | 12+ |
| family's overall | | | | Months or |
| plan for your care. | | | | Never |
| | | | | N/A |
| 7. Develop a plan | Level of | Completed | Level of | If No, when |
| for medically | Importance | Yes/No | Satisfaction | do you plan |
| evaluating your | (1-2-3-4-5) | | (1-2-3-4-5) | to complete |
| current and future | N/A | | | the task? |
| driving skills and | | | | 1-3-6-9- |
| secure medical | | | | 12+ |
| assistance for | | | | Months or |
| correcting existing | | | | Never |
| conditions that | | | | N/A |
| limit your capacity | | | | |
| to drive safely. | | | | |
| 8. Have | Level of | Completed | Level of | If No, when |
| appropriate | Importance | Yes/No | Satisfaction | do you plan |
| members of your | (1-2-3-4-5) | | (1-2-3-4-5) | to complete |
| treatment team | N/A | | | the task? |
| conduct an | | | | 1-3-6-9- |
| assessment of your | | | | 12+ |
| residence to insure | | | | Months or |
| and maximize | | | | Never |
| your overall | | | | N/A |
| safety. | | | | |
| 9. Learn about and | Level of | Completed | Level of | If No, when |
| use new devices, | Importance | Yes/No | Satisfaction | do you plan |
| technological | (1-2-3-4-5) | | (1-2-3-4-5) | to complete |
| advances, | N/A | | | the task? |
| treatments, and | | | | 1-3-6-9- |
| medical | | | | 12+ |
| equipment that can | | | | Months or |
| help you to | | | | Never |
| maximize your | | | | N/A |
| independence, | | | | |
| dignity, and | | | | |
| overall welfare | | | | |
| (i.e., develop a | | | | |
| plan that would | | | | |
| allow you to | | | | |
| remain safely in | | | | |
| your home as long | | | | |
| as possible, | | | | |
| evaluate the safety | | | | |
| of your current | | | | |
| living situation | | | | |
| (possibility of | | | | |
| falls, isolation, | | | | |
| scams), & employ | | | | |
| strategies (e.g., | | | | |
| panic-button | | | | |
| service) and home | | | | |
| enhancements to | | | | |
| help prevent falls | | | | |
| (e.g., take less | | | | |
| than five | | | | |
| medications, | | | | |
| balance-related | | | | |
| exercise, grab | | | | |
| bars, etc.). | | | | |
| 10. Identify ways | Level of | Completed | Level of | If No, when |
| to age successfully | Importance | Yes/No | Satisfaction | do you plan |
| (avoid disease and | (1-2-3-4-5) | | (1-2-3-4-5) | to complete |
| disability, | N/A | | | the task? |
| maximize | | | | 1-3-6-9- |
| cognitive/intellectual/ | | | | 12+ |
| psychiatric | | | | Months or |
| fitness, remain | | | | Never |
| actively engaged | | | | N/A |
| in life, and | | | | |
| develop | | | | |
| spiritually). | | | | |
| 11. Know how to | Level of | Completed | Level of | If No, when |
| locate leading | Importance | Yes/No | Satisfaction | do you plan |
| researchers and | (1-2-3-4-5) | | (1-2-3-4-5) | to complete |
| medical experts in | N/A | | | the task? |
| area(s) of critical | | | | 1-3-6-9- |
| need that you face. | | | | 12+ |
| | | | | Months or |
| | | | | Never |
| | | | | N/A |
| 12. Thoroughly | Level of | Completed | Level of | If No, when |
| familiarize | Importance | Yes/No | Satisfaction | do you plan |
| yourself with the | (1-2-3-4-5) | | (1-2-3-4-5) | to complete |
| full range of | N/A | | | the task? |
| services for older | | | | 1-3-6-9- |
| adults available in | | | | 12+ |
| the community | | | | Months or |
| where reside and | | | | Never |
| place yourself on | | | | N/A |
| ‘waiting lists’ for | | | | |
| services that may | | | | |
| be accessible if | | | | |
| needed in the | | | | |
| future. | | | | |
| LEGAL- | Level of | Completed | Satisfaction | Plans to |
| FINANCIAL- | Importance | | | Complete |
| INSURANCE | | | | |
| TASKS | | | | |
| 13. Secure the | Level of | Completed | Level of | If No, when |
| services of a | Importance | Yes/No | Satisfaction | do you plan |
| qualified, elder | (1-2-3-4-5) | | (1-2-3-4-5) | to complete |
| law attorney in | N/A | | | the task? |
| your state to | | | | 1-3-6-9- |
| review and make | | | | 12+ |
| recommendations | | | | Months or |
| regarding your | | | | Never |
| estate and elder | | | | N/A |
| care plan; and if | | | | |
| you are | | | | |
| experiencing | | | | |
| dementia, the | | | | |
| services of a | | | | |
| geriatric certified | | | | |
| psychiatrist, | | | | |
| psychologist, or | | | | |
| neurologist may | | | | |
| be needed to | | | | |
| establish your | | | | |
| competency and | | | | |
| capacity to make | | | | |
| decisions in your | | | | |
| best interests. | | | | |
| 14. Discuss with | Level of | Completed | Level of | If No, when |
| your children the | Importance | Yes/No | Satisfaction | do you plan |
| advantages of | (1-2-3-4-5) | | (1-2-3-4-5) | to complete |
| completing and | N/A | | | the task? |
| the consequences | | | | 1-3-6-9- |
| of neglecting to | | | | 12+ |
| complete a variety | | | | Months or |
| of legal | | | | Never |
| documents: Will; | | | | N/A |
| Durable Power of | | | | |
| Attorney; | | | | |
| Trust/Revocable | | | | |
| Living Trust; Joint | | | | |
| Ownership/Tenancy; | | | | |
| and other | | | | |
| documents | | | | |
| recommended by | | | | |
| your elder law | | | | |
| attorney. | | | | |
| 15. Discuss with | Level of | Completed | Level of | If No, when |
| your children the | Importance | Yes/No | Satisfaction | do you plan |
| advantages of | (1-2-3-4-5) | | (1-2-3-4-5) | to complete |
| completing and | N/A | | | the task? |
| the consequences | | | | 1-3-6-9- |
| of neglecting to | | | | 12+ |
| complete a variety | | | | Months or |
| of documents | | | | Never |
| related to advance | | | | N/A |
| directives in your | | | | |
| state: Living Will; | | | | |
| Do Not | | | | |
| Resuscitate | | | | |
| Orders; Durable | | | | |
| Power of Attorney | | | | |
| for Health Care | | | | |
| (Proxy); and other | | | | |
| related documents. | | | | |
| 16. Secure the | Level of | Completed | Level of | If No, when |
| services of a | Importance | Yes/No | Satisfaction | do you plan |
| qualified Certified | (1-2-3-4-5) | | (1-2-3-4-5) | to complete |
| Public accountant | N/A | | | the task? |
| to review and | | | | 1-3-6-9- |
| interact with you | | | | 12+ |
| elder law attorney | | | | Months or |
| before finalizing | | | | Never |
| recommendations | | | | N/A |
| regarding your | | | | |
| estate and elder | | | | |
| care plan. | | | | |
| 17. Secure the | Level of | Completed | Level of | If No, when |
| services of a | Importance | Yes/No | Satisfaction | do you plan |
| qualified Financial | (1-2-3-4-5) | | (1-2-3-4-5) | to complete |
| Planner to review | N/A | | | the task? |
| and interact with | | | | 1-3-6-9- |
| your elder law | | | | 12+ |
| attorney and CPA | | | | Months or |
| to review and | | | | Never |
| make | | | | N/A |
| recommendations | | | | |
| regarding your | | | | |
| overall estate and | | | | |
| elder care plan. | | | | |
| 18. Place all legal | Level of | Completed | Level of | If No, when |
| and important | Importance | Yes/No | Satisfaction | do you plan |
| financial | (1-2-3-4-5) | | (1-2-3-4-5) | to complete |
| documents, to | N/A | | | the task? |
| include a list of | | | | 1-3-6-9- |
| family valuables | | | | 12+ |
| (furniture, jewelry, | | | | Months or |
| etc.), in an | | | | Never |
| accessible, fire | | | | N/A |
| safe, secure | | | | |
| location. Consider | | | | |
| obtaining a DVD | | | | |
| or Video of your | | | | |
| residence, making | | | | |
| sure to capture all | | | | |
| valuables, | | | | |
| particularly those | | | | |
| that can not be | | | | |
| secured and not | | | | |
| specifically | | | | |
| insured. | | | | |
| 19. If you have a | Level of | Completed | Level of | If No, when |
| child currently | Importance | Yes/No | Satisfaction | do you plan |
| serving on active | (1-2-3-4-5) | | (1-2-3-4-5) | to complete |
| duty in the | N/A | | | the task? |
| military, | | | | 1-3-6-9- |
| determine if it | | | | 12+ |
| would be | | | | Months or |
| advantageous | | | | Never |
| medically and | | | | N/A |
| financially to | | | | |
| make you a legal | | | | |
| dependent; and, if | | | | |
| so, identify the | | | | |
| implications and | | | | |
| steps of becoming | | | | |
| a legal dependent. | | | | |
| 20. Work with | Level of | Completed | Level of | If No, when |
| your child to | Importance | Yes/No | Satisfaction | do you plan |
| establish a | (1-2-3-4-5) | | (1-2-3-4-5) | to complete |
| comprehensive | N/A | | | the task? |
| budgetary plan by | | | | 1-3-6-9- |
| identifying your | | | | 12+ |
| assets, liabilities, | | | | Months or |
| income | | | | Never |
| entitlements | | | | N/A |
| (verification of: | | | | |
| social security, | | | | |
| pensions, military | | | | |
| and other forms of | | | | |
| retirement | | | | |
| compensation), | | | | |
| investment | | | | |
| strategies, and | | | | |
| expenses; and | | | | |
| review this | | | | |
| information with | | | | |
| your attorney, | | | | |
| accountant, and | | | | |
| financial planner | | | | |
| so as to maximize | | | | |
| your overall | | | | |
| financial security. | | | | |
| 21. Maximize the | Level of | Completed | Level of | If No, when |
| advantages of the | Importance | Yes/No | Satisfaction | do you plan |
| Internet with a | (1-2-3-4-5) | | (1-2-3-4-5) | to complete |
| secure home- | N/A | | | the task? |
| computer system. | | | | 1-3-6-9- |
| | | | | 12+ |
| | | | | Months or |
| | | | | Never |
| | | | | N/A |
| 22. Review your | Level of | Completed | Level of | If No, when |
| credit history. If | Importance | Yes/No | Satisfaction | do you plan |
| applicable, make | (1-2-3-4-5) | | (1-2-3-4-5) | to complete |
| sure you have | N/A | | | the task? |
| access to joint or | | | | 1-3-6-9- |
| separate credit, | | | | 12+ |
| and make sure that | | | | Months or |
| you have taken | | | | Never |
| safety precautions | | | | N/A |
| to prevent theft | | | | |
| and scams | | | | |
| (computer, mail & | | | | |
| phone) targeted at | | | | |
| older people. | | | | |
| 23. Determine the | Level of | Completed | Level of | If No, when |
| full extent of your | Importance | Yes/No | Satisfaction | do you plan |
| health, life, & | (1-2-3-4-5) | | (1-2-3-4-5) | to complete |
| property insurance | N/A | | | the task? |
| coverage (to | | | | 1-3-6-9- |
| include Medicare | | | | 12+ |
| and Medicaid); | | | | Months or |
| check for cost | | | | Never |
| saving strategies; | | | | N/A |
| and utilize an | | | | |
| insurance | | | | |
| organizer to | | | | |
| simplify filing and | | | | |
| maximize your | | | | |
| claims. | | | | |
| 24. Investigate the | Level of | Completed | Level of | If No, when |
| cost and financing | Importance | Yes/No | Satisfaction | do you plan |
| of relevant long | (1-2-3-4-5) | | (1-2-3-4-5) | to complete |
| term care | N/A | | | the task? |
| scenarios (e.g., | | | | 1-3-6-9- |
| assisted living, | | | | 12+ |
| nursing home, | | | | Months or |
| aging in place | | | | Never |
| facilities, | | | | N/A |
| retirement centers, | | | | |
| etc.) taking into | | | | |
| account your | | | | |
| current and | | | | |
| projected health | | | | |
| care status and the | | | | |
| likelihood that you | | | | |
| may have to move | | | | |
| more than once; | | | | |
| and enlist the | | | | |
| advice of you | | | | |
| attorney, | | | | |
| accountant, and | | | | |
| financial planner, | | | | |
| consider the | | | | |
| recommendations | | | | |
| of your treatment | | | | |
| team, particularly | | | | |
| your primary care | | | | |
| physician; and | | | | |
| seek to minimize | | | | |
| moves while | | | | |
| maximizing your | | | | |
| health, ignity, and | | | | |
| access to family | | | | |
| and friends. | | | | |
| 25. Work with | Level of | Completed | Level of | If No, when |
| your children to | Importance | Yes/No | Satisfaction | do you plan |
| complete a | (1-2-3-4-5) | | (1-2-3-4-5) | to complete |
| preferred | N/A | | | the task? |
| possession list, so | | | | 1-3-6-9- |
| that you can | | | | 12+ |
| minimize future | | | | Months or |
| family conflict | | | | Never |
| over ‘who’ gets | | | | N/A |
| ‘what’ from the | | | | |
| estate (highly | | | | |
| valued furniture, | | | | |
| heirlooms, other | | | | |
| family valuables); | | | | |
| and consider | | | | |
| incorporating the | | | | |
| document into | | | | |
| your Will. | | | | |
| 26. Insure that all | Level of | Completed | Level of | If No, when |
| legal, financial, | Importance | Yes/No | Satisfaction | do you plan |
| and insurance | (1-2-3-4-5) | | (1-2-3-4-5 | to complete |
| plans are | N/A | | | the task? |
| coordinated with | | | | 1-3-6-9- |
| those of your | | | | 12+ |
| partner to the | | | | Months or |
| fullest extent | | | | Never |
| possible. | | | | N/A |
| 27. Consider | Level of | Completed | Level of | If No, when |
| whether there may | Importance | Yes/No | Satisfaction | do you plan |
| be a future need | (1-2-3-4-5) | | (1-2-3-4-5 | to complete |
| for public benefits, | N/A | | | the task? |
| such as Medicaid, | | | | 1-3-6-9- |
| SSI or other | | | | 12+ |
| income-based | | | | Months or |
| benefits programs | | | | Never |
| so that planning | | | | N/A |
| can take place to | | | | |
| insure the | | | | |
| disposition of | | | | |
| assets and to | | | | |
| insurance | | | | |
| compliance with | | | | |
| program | | | | |
| regulations. | | | | |
| 28. Review legal | Level of | Completed | Level of | If No, when |
| ownership status | Importance | Yes/No | Satisfaction | do you plan |
| of real property, | (1-2-3-4-5) | | (1-2-3-4-5 | to complete |
| accounts and other | N/A | | | the task? |
| titled property of | | | | 1-3-6-9- |
| both a tangible | | | | 12+ |
| and intangible | | | | Months or |
| nature to insure | | | | Never |
| that both present | | | | N/A |
| and future | | | | |
| ownership and | | | | |
| control of the | | | | |
| property complies | | | | |
| with your client | | | | |
| wishes... | | | | |
| 29. Review plans | Level of | Completed | Level of | If No, when |
| for the | Importance | Yes/No | Satisfaction | do you plan |
| management and | (1-2-3-4-5) | | (1-2-3-4-5 | to complete |
| maintenance of | N/A | | | the task? |
| real property. | | | | 1-3-6-9- |
| | | | | 12+ |
| | | | | Months or |
| | | | | Never |
| | | | | N/A |
| 30. Schedule | Level of | Completed | Level of | If No, when |
| periodic review of | Importance | Yes/No | Satisfaction | do you plan |
| health care | (1-2-3-4-5) | | (1-2-3-4-5 | to complete |
| coverage to insure | N/A | | | the task? |
| maximum | | | | 1-3-6-9- |
| coverage at most | | | | 12+ |
| economical cost, | | | | Months or |
| including the | | | | Never |
| coordination of | | | | N/A |
| private insurance, | | | | |
| Medicare parts A, | | | | |
| B and D, Medigap | | | | |
| coverage, and any | | | | |
| supplemental | | | | |
| insurance. | | | | |
| FAMILY TASKS | Level of | Completed | Satisfaction | Plans to |
| | Importance | | | Complete |
| 31. Discuss with | Level of | Completed | Level of | If No, when |
| your children y | Importance | Yes/No | Satisfaction | do you plan |
| your own values | (1-2-3-4-5) | | (1-2-3-4-5) | to complete |
| about how you | N/A | | | the task? |
| would like them to | | | | 1-3-6-9- |
| be involved in.’ | | | | 12+ |
| your care. | | | | Months or |
| | | | | Never |
| | | | | N/A |
| 32. Develop a | Level of | Completed | Level of | If No, when |
| sensitive, | Importance | Yes/No | Satisfaction | do you plan |
| respectful strategy | (1-2-3-4-5) | | (1-2-3-4-5 | to complete |
| for addressing | N/A | | | the task? |
| children who are | | | | 1-3-6-9- |
| unwilling to | | | | 12+ |
| discuss issues | | | | Months or |
| about your care. | | | | Never |
| | | | | N/A |
| 33. Organize a | Level of | Completed | Level of | If No, when |
| family meeting to | Importance | Yes/No | Satisfaction | do you plan |
| develop an initial | (1-2-3-4-5) | | (1-2-3-4-5) | to complete |
| plan about how | N/A | | | the task? |
| each person can be | | | | 1-3-6-9- |
| involved and of | | | | 12+ |
| assistance in | | | | Months or |
| caring for you. | | | | Never |
| | | | | N/A |
| 34. Work with | Level of | Completed | Level of | If No, when |
| your children to | Importance | Yes/No | Satisfaction | do you plan |
| complete a | (1-2-3-4-5) | | (1-2-3-4-5) | to complete |
| comprehensive, | N/A | | | the task? |
| written and | | | | 1-3-6-9- |
| computerized | | | | 12+ |
| version of your | | | | Months or |
| care plan that | | | | Never |
| could be made | | | | N/A |
| available to care | | | | |
| givers and | | | | |
| members of your | | | | |
| treatment team. | | | | |
| 35. Develop | Level of | Completed | Level of | If No, when |
| specific strategies | Importance | Yes/No | Satisfaction | do you plan |
| for responding to | (1-2-3-4-5) | | (1-2-3-4-5) | to complete |
| crises (e.g., health | N/A | | | the task? |
| event, break-in, | | | | 1-3-6-9- |
| and scams, natural | | | | 12+ |
| and human | | | | Months or |
| disasters). | | | | Never |
| | | | | N/A |
| ) 36. Identify | Level of | Completed | Level of | If No, when |
| evaluation criteria | Importance | Yes/No | Satisfaction | do you plan |
| for employing all | (1-2-3-4-5) | | (1-2-3-4-5) | to complete |
| professional care | N/A | | | the task? |
| givers, home care | | | | 1-3-6-9- |
| workers, and other | | | | 12+ |
| employed | | | | Months or |
| caregivers who | | | | Never |
| might work with | | | | N/A |
| you. | | | | |
| 37. Develop | Level of | Completed | Level of | If No, when |
| specific strategies | Importance | Yes/No | Satisfaction | do you plan |
| for encouraging | (1-2-3-4-5) | | (1-2-3-4-5) | to complete |
| your children to | N/A | | | the task? |
| take care of their | | | | 1-3-6-9- |
| own health and | | | | 12+ |
| well-being while | | | | Months or |
| they are caring for | | | | Never |
| you. | | | | N/A |
| 38. Assess the | Level of | Completed | Level of | If No, when |
| quality of care in | Importance | Yes/No | Satisfaction | do you plan |
| long term facilities | (1-2-3-4-5) | | (1-2-3-4-5) | to complete |
| relevant to you | N/A | | | the task? |
| (E.g., nursing | | | | 1-3-6-9- |
| homes, assisted | | | | 12+ |
| living facilities, | | | | Months or |
| dementia care | | | | Never |
| unites, aging in | | | | N/A |
| place facilities). | | | | |
| 39. Consider how | Level of | Completed | Level of | If No, when |
| a “pet” can | Importance | Yes/No | Satisfaction | do you plan |
| contribute to your | (1-2-3-4-5) | | (1-2-3-4-5) | to complete |
| well being. | N/A | | | the task? |
| | | | | 1-3-6-9- |
| | | | | 12+ |
| | | | | Months or |
| | | | | Never |
| | | | | N/A |
| 40. Know what to | Level of | Completed | Level of | If No, when |
| look for regarding | Importance | Yes/No | Satisfaction | do you plan |
| changes in your | (1-2-3-4-5) | | (1-2-3-4-5) | to complete |
| health that might | N/A | | | the task? |
| indicate when you | | | | 1-3-6-9- |
| can no longer live | | | | 12+ |
| independently, and | | | | Months or |
| seek a medical | | | | Never |
| evaluation based | | | | N/A |
| upon this | | | | |
| information so that | | | | |
| you can make an | | | | |
| informed decision | | | | |
| about where you | | | | |
| parent should live. | | | | |
| SPIRITUAL- | Level of | Completed | Satisfaction | Plans to |
| EMOTIONAL | Importance | | | Complete |
| TASKS | | | | |
| 41. Learn to rely | Level of | Completed | Level of | If No, when |
| on your | Importance | Yes/No | Satisfaction | do you plan |
| relationship with | (1-2-3-4-5) | | (1-2-3-4-5) | to complete |
| God in accepting | N/A | | | the task? |
| care from others. | | | | 1-3-6-9- |
| | | | | 12+ |
| | | | | Months or |
| | | | | Never |
| | | | | N/A |
| 42. Take time to | Level of | Completed | Level of | If No, when |
| understand and be | Importance | Yes/No | Satisfaction | do you plan |
| sensitive to your | (1-2-3-4-5) | | (1-2-3-4- | to complete |
| children's | N/A | | 5) | the task? |
| spirituality and | | | | 1-3-6-9 |
| religiosity or lack | | | | 12+ |
| thereof. | | | | Months or |
| | | | | Never |
| | | | | N/A |
| 43. Make peace | Level of | Completed | Level of | If No, when |
| with your children | Importance | Yes/No | Satisfaction | do you plan |
| regarding their | (1-2-3-4-5) | | (1-2-3-4-5) | to complete |
| religious and | N/A | | | the task? |
| spiritual beliefs. | | | | 1-3-6-9- |
| | | | | 12+ |
| | | | | Months or |
| | | | | Never |
| | | | | N/A |
| 44. Make plans to | Level of | Completed | Level of | If No, when |
| capture your | Importance | Yes/No | Satisfaction | do you plan |
| religious and | (1-2-3-4-5) | | (1-2-3-4-5) | to complete |
| personal life story | N/A | | | the task? |
| to share with | | | | 1-3-6-9- |
| younger | | | | 12+ |
| generations. | | | | Months or |
| | | | | Never |
| | | | | N/A |
| 45. Create a list of | Level of | Completed | Level of | If No, when |
| local religious | Importance | Yes/No | Satisfaction | do you plan |
| programs that | (1-2-3-4-5) | | (1-2-3-4-5) | to complete |
| could enhance | N/A | | | the task? |
| your overall health | | | | 1-3-6-9- |
| and welfare, and | | | | 12+ |
| participate | | | | Months or |
| regularly in | | | | Never |
| programs of your | | | | N/A |
| choice. | | | | |
| 46. Create a list of | Level of | Completed | Level of | If No, when |
| religiously | Importance | Yes/No | Satisfaction | do you plan |
| motivated | (1-2-3-4-5) | | (1-2-3-4-5) | to complete |
| opportunities for | N/A | | | the task? |
| service, and | | | | 1-3-6-9- |
| identify specific | | | | 12+ |
| ways that you | | | | Months or |
| could serve those | | | | Never |
| in need. | | | | N/A |
| 47. If you and | Level of | Completed | Level of | If No, when |
| your children are | Importance | Yes/No | Satisfaction | do you plan |
| spiritually | (1-2-3-4-5) | | (1-2-3-4-5) | to complete |
| compatible, | N/A | | | the task? |
| develop the habit | | | | 1-3-6-9- |
| of praying | | | | 12+ |
| together about | | | | Months or |
| mutual needs. | | | | Never |
| | | | | N/A |
| 48. Develop and | Level of | Completed | Level of | If No, when |
| share with your | Importance | Yes/No | Satisfaction | do you plan |
| children a specific | (1-2-3-4-5) | | (1-2-3-4-5) | to complete |
| end of life plan | N/A | | | the task? |
| that is consistent | | | | 1-3-6-9- |
| with your religious | | | | 12+ |
| wishes. | | | | Months or |
| | | | | Never |
| | | | | N/A |
| 49. Put your | Level of | Completed | Level of | If No, when |
| children in contact | Importance | Yes/No | Satisfaction | do you plan |
| with at least one | (1-2-3-4-5) | | (1-2-3-4-5) | to complete |
| member of your | N/A | | | the task? |
| faith community | | | | 1-3-6-9- |
| and cultivate | | | | 12+ |
| specific ways your | | | | Months or |
| faith based | | | | Never |
| community can be | | | | N/A |
| involved in your | | | | |
| care plan. | | | | |

Sample demographics:

```
Please provide your parent's: area code   & zip code
Does your employer have an elder care program?   Yes   No   N/A
How would you describe your parent's religious affiliation?
    Observant Jew/Orthodox Judaism/Conservative Jew
    Reformed Jew
    Roman Catholic
    Eastern Orthodox
    Assemblies of God (Pentecostal)
    Baptist (Over 27 different groups)
    Christian Church (Disciples of Christ)
    Church of the Brethren
    Church of the Nazarene
    Episcopal (Anglican)
    Lutheran (10 different types)
    Mennonite (12 Different types)
    Methodist (over 20 different types)
    Presbyterian (10 Different types)
    Quaker (Friends)
    Salvation Army
    Seventh-Day Adventist
    United Church of Christ
    Islam
    American Muslim Mission
    Christian Science
    Jehovah's Witnesses
    The church of Jesus Christ of Latter-Day Saints
    Unitarian Universalist
    Confucianism
    Buddhism
    HinduismSilhism
    Taoism
    Methodist
    Lutheran
    Catholic
    Jewish
    Buddhist
    Islamic
    Other (specify)
How many miles do you live from your parent?
```

PARENT CARE READINESS ASSESSMENT - Adult Child Version

| | | | | |
|---|---|---|---|---|
| 1. Schedule a | Level of | Completed | Level of | If No, when |
| comprehensive | Importance | Yes/No | Satisfaction | do you plan |
| geriatric assessment | (1-2-3-4- | | (1-2-3-4-5) | to complete |
| with a certified | 5) | | | the task? |
| geriatric physician | N/A | | | 1-3-6-9- |
| (family practice or an | | | | 12+ |
| internist), who | | | | Months or |
| specializes in the care | | | | Never |
| of older adults and | | | | N/A |
| who can serve as | | | | |
| either your parent's | | | | |
| primary care doctor or | | | | |
| as a consultant to your | | | | |
| parent's primary care | | | | |
| physician. If your | | | | |
| parent is experiencing | | | | |
| dementia or late life | | | | |
| mental health | | | | |
| problems, or is | | | | |
| already located in a | | | | |
| Nursing Home, you | | | | |
| may want to include a | | | | |
| psychiatrist certified | | | | |
| in geriatrics. | | | | |
| 2. Find out what your | Level of | Completed | Level of | If No, when |
| parent's current | Importance | Yes/No | Satisfaction | do you plan |
| medical conditions | (1-2-3-4- | | (1-2-3-4-5) | to complete |
| (diagnoses) are and | 5) | | | the task? |
| learn more about these | N/A | | | 1-3-6-9- |
| conditions, so that you | | | | 12+ |
| can monitor his/her | | | | Months or |
| health status and | | | | Never |
| enhance the quality of | | | | N/A |
| care he/she receives. | | | | |
| 3. Understand your | Level of | Completed | Level of | If No, when |
| parent's current | Importance | Yes/No | Satisfaction | do you plan |
| functional status (life | (1-2-3-4- | | (1-2-3-4-5) | to complete |
| skills necessary to live | 5) | | | the task? |
| independently) and | N/A | | | 1-3-6-9- |
| how to monitor and | | | | 12+ |
| respond to changes in | | | | Months or |
| that status, along with | | | | Never |
| other health changes. | | | | N/A |
| 4. Learn how to | Level of | Completed | Level of | If No, when |
| become an active | Importance | Yes/No | Satisfaction | do you plan |
| member of your | (1-2-3-4- | | (1-2-3-4-5) | to complete |
| parent's care team by | 5) | | | the task? |
| maximizing your | N/A | | | 1-3-6-9- |
| parent's medical | | | | 12+ |
| compliance to | | | | Months or |
| appropriate treatment | | | | Never |
| plans; learn how to | | | | N/A |
| question and clarify | | | | |
| specific aspects of the | | | | |
| medical care | | | | |
| recommended. | | | | |
| 5. Develop a strategy | Level of | Completed | Level of | If No, when |
| for determining what | Importance | Yes/No | Satisfaction | do you plan |
| prescriptions, | (1-2-3-4- | | (1-2-3-4-5) | to complete |
| medications, and | 5) | | | the task? |
| over-the-counter | N/A | | | 1-3-6-9- |
| medicines your parent | | | | 12+ |
| takes and has access | | | | Months or |
| to; help your parent to | | | | Never |
| be on only those | | | | N/A |
| medications she/he | | | | |
| needs to be on, and | | | | |
| not to be on any over | | | | |
| the counter or | | | | |
| prescriptions that | | | | |
| she/he does not need | | | | |
| to be on; and have a | | | | |
| specific plan to | | | | |
| address your parent's | | | | |
| medication needs in | | | | |
| an emergency | | | | |
| requiring his/her | | | | |
| evacuation. | | | | |
| 6. Schedule an | Level of | Completed | Level of | If No, when |
| appointment with | Importance | Yes/No | Satisfaction | do you plan |
| local geriatric care | (1-2-3-4- | | (1-2-3-4-5) | to complete |
| manager(s) to | 5) | | | the task? |
| develop, review and | N/A | | | 1-3-6-9- |
| enhance your family's | | | | 12+ |
| overall elder care | | | | Months or |
| plan. | | | | Never |
| | | | | N/A |
| 7. Develop a plan for | Level of | Completed | Level of | If No, when |
| medically evaluating | Importance | Yes/No | Satisfaction | do you plan |
| your parent's current | (1-2-3-4- | | (1-2-3-4-5) | to complete |
| and future driving | 5) | | | the task? |
| skills and secure | N/A | | | 1-3-6-9- |
| medical assistance for | | | | 12+ |
| correcting existing | | | | Months or |
| conditions that limit | | | | Never |
| his/her capacity to | | | | N/A |
| drive safely. | | | | |
| 8. Have appropriate | Level of | Completed | Level of | If No, when |
| members of your | Importance | Yes/No | Satisfaction | do you plan |
| parent's treatment | (1-2-3-4- | | (1-2-3-4-5) | to complete |
| team conduct an | 5) | | | the task? |
| assessment of your | N/A | | | 1-3-6-9- |
| parent's residence to | | | | 12+ |
| insure and maximize | | | | Months or |
| his/her overall safety. | | | | Never |
| | | | | N/A |
| 9. Learn about and use new | Level of | Completed | Level of | If No, when |
| devices, technological advances, | Importance | Yes/No | Satisfaction | do you plan |
| treatments, and medical | (1-2-3-4- | | (1-2-3-4-5) | to complete |
| equipment that can help your | 5) | | | the task? |
| parent to maximize his/her | N/A | | | 1-3-6-9- |
| independence, dignity, and | | | | 12+ |
| overall welfare | | | | Months or |
| (i.e., develop a plan that would | Never | | | |
| allow your parent(s) to remain | N/A | | | |
| safely in their home as long | | | | |
| as possible, evaluate the safety | | | | |
| of your parent(s)' current | | | | |
| living situation | | | | |
| (possibility of falls, | | | | |
| isolation, scams), & | | | | |
| employ strategies | | | | |
| (e.g., panic-button service) | | | | |
| and home enhancements to help | | | | |
| prevent falls (e.g., | | | | |
| take less than five | | | | |
| medications, balance- | | | | |
| related exercise, grab | | | | |
| bars, etc.). | | | | |
| 10. Identify ways to | Level of | Completed | Level of | If No, when |
| help your parent age | Importance | Yes/No | Satisfaction | do you plan |
| successfully (avoid | (1-2-3-4- | | (1-2-3-4-5) | to complete |
| disease and disability, | 5) | | | the task? |
| maximize | N/A | | | 1-3-6-9- |
| cognitive/intellectual/ | | | | 12+ |
| psychiatric fitness, | | | | Months or |
| remain actively | | | | Never |
| engaged in life, and | | | | N/A |
| develop spiritually). | | | | |
| 11. Know how to | Level of | Completed | Level of | If No, when |
| locate leading | Importance | Yes/No | Satisfaction | do you plan |
| researchers and | (1-2-3-4- | | (1-2-3-4-5) | to complete |
| medical experts in | 5) | | | the task? |
| area(s) of critical need | N/A | | | 1-3-6-9- |
| that your parent faces. | | | | 12+ |
| | | | | Months or |
| | | | | Never |
| | | | | N/A |
| 12. Thoroughly | Level of | Completed | Level of | If No, when |
| familiarize yourself | Importance | Yes/No | Satisfaction | do you plan |
| with the full range of | (1-2-3-4- | | (1-2-3-4-5) | to complete |
| services for older | 5) | | | the task? |
| adults available in the | N/A | | | 1-3-6-9- |
| community where | | | | 12+ |
| your parent resides | | | | Months or |
| and place your parent | | | | Never |
| on ‘waiting lists’ for | | | | N/A |
| services that may be | | | | |
| accessible if needed in | | | | |
| the future. | | | | |
| LEGAL- | Level of | Completed | Satisfaction | Plans to |
| FINANCIAL- | Importance | | | Complete |
| INSURANCE | | | | |
| TASKS | | | | |
| 13. Secure the | Level of | Completed | Level of | If No, when |
| services of a qualified, | Importance | Yes/No | Satisfaction | do you plan |
| elder law attorney in | (1-2-3-4- | | (1-2-3-4-5) | to complete |
| the state where your | 5) | | | the task? |
| parent resides to | N/A | | | 1-3-6-9- |
| review and make | | | | 12+ |
| recommendations | | | | Months or |
| regarding your | | | | Never |
| parent's estate and | | | | N/A |
| elder care plan; and if | | | | |
| your parent is | | | | |
| experiencing | | | | |
| dementia, the services | | | | |
| of a geriatric certified | | | | |
| psychiatrist, | | | | |
| psychologist, or | | | | |
| neurologist may be | | | | |
| needed to establish | | | | |
| your parent's | | | | |
| competency and | | | | |
| capacity to make | | | | |
| decisions in his/her | | | | |
| own best interests. | | | | |
| 14. Discuss with your | Level of | Completed | Level of | If No, when |
| parent the advantages | Importance | Yes/No | Satisfaction | do you plan |
| of completing and the | (1-2-3-4- | | (1-2-3-4-5) | to complete |
| consequences of | 5) | | | the task? |
| neglecting to complete | N/A | | | 1-3-6-9- |
| a variety of legal | | | | 12+ |
| documents: Will; | | | | Months or |
| Durable Power of | | | | Never |
| Attorney; | | | | N/A |
| Trust/Revocable | | | | |
| Living Trust; Joint | | | | |
| Ownership/Tenancy; | | | | |
| and other documents | | | | |
| recommended by your | | | | |
| parent's elder law | | | | |
| attorney. | | | | |
| 15. Discuss with your | Level of | Completed | Level of | If No, when |
| parent the advantages | Importance | Yes/No | Satisfaction | do you plan |
| of completing and the | (1-2-3-4- | | (1-2-3-4-5) | to complete |
| consequences of | 5) | | | the task? |
| neglecting to complete | N/A | | | 1-3-6-9- |
| a variety of | | | | 12+ |
| documents related to | | | | Months or |
| advance directives in | | | | Never |
| the state where your | | | | N/A |
| parent resides: Living | | | | |
| Will; Do Not | | | | |
| Resuscitate Orders; | | | | |
| Durable Power of | | | | |
| Attorney for Health | | | | |
| Care (Proxy); and | | | | |
| other related | | | | |
| documents. | | | | |
| 16. Secure the | Level of | Completed | Level of | If No, when |
| services of a qualified | Importance | Yes/No | Satisfaction | do you plan |
| Certified Public | (1-2-3-4- | | (1-2-3-4-5) | to complete |
| accountant to review | 5) | | | the task? |
| and interact with your | N/A | | | 1-3-6-9- |
| parent's elder law | | | | 12+ |
| attorney in the state | | | | Months or |
| where your parent | | | | Never |
| resides before | | | | N/A |
| finalizing | | | | |
| recommendations | | | | |
| regarding your | | | | |
| parent's estate and | | | | |
| elder care plan. | | | | |
| 17. Secure the | Level of | Completed | Level of | If No, when |
| services of a qualified | Importance | Yes/No | Satisfaction | do you plan |
| Financial Planner to | (1-2-3-4- | | (1-2-3-4-5) | to complete |
| review and interact | 5) | | | the task? |
| with your parent's | N/A | | | 1-3-6-9- |
| elder law attorney and | | | | 12+ |
| CPA in the state | | | | Months or |
| where your parent | | | | Never |
| resides to review and | | | | N/A |
| make | | | | |
| recommendations | | | | |
| regarding your | | | | |
| parent's overall estate | | | | |
| and elder care plan. | | | | |
| 18. Encourage and | Level of | Completed | Level of | If No, when |
| assist with the | Importance | Yes/No | Satisfaction | do you plan |
| placement of all legal | (1-2-3-4- | | (1-2-3-4-5) | to complete |
| and important | 5) | | | the task? |
| financial documents, | N/A | | | 1-3-6-9- |
| to include a list of | | | | 12+ |
| family valuables | | | | Months or |
| (furniture, jewelry, | | | | Never |
| etc.), in an accessible, | | | | N/A |
| fire safe, secure | | | | |
| location. Consider | | | | |
| obtaining a DVD or | | | | |
| Video of your parent's | | | | |
| residence, making | | | | |
| sure to capture all | | | | |
| valuables, particularly | | | | |
| those that can not be | | | | |
| secured and not | | | | |
| specifically insured. | | | | |
| 19. If you currently | Level of | Completed | Level of | If No, when |
| serve on active duty in | Importance | Yes/No | Satisfaction | do you plan |
| the military, | (1-2-3-4- | | (1-2-3-4-5) | to complete |
| determine if it would | 5) | | | the task? |
| be advantageous | N/A | | | 1-3-6-9- |
| medically and | | | | 12+ |
| financially to make | | | | Months or |
| your parent(s) legal | | | | Never |
| dependents; and, if so, | | | | N/A |
| identify the | | | | |
| implications and steps | | | | |
| of making your parent | | | | |
| a legal dependent. | | | | |
| 20. Assist your parent | Level of | Completed | Level of | If No, when |
| in establishing a | Importance | Yes/No | Satisfaction | do you plan |
| comprehensive | (1-2-3-4- | | (1-2-3-4-5) | to complete |
| budgetary plan by | 5) | | | the task? |
| identifying his/her | N/A | | | 1-3-6-9- |
| assets, liabilities, | | | | 12+ |
| income entitlements | | | | Months or |
| (verification of: social | | | | Never |
| security, pensions, | | | | N/A |
| military and other | | | | |
| forms of retirement | | | | |
| compensation), | | | | |
| investment strategies, | | | | |
| and expenses; and | | | | |
| review this | | | | |
| information with your | | | | |
| parent's attorney, | | | | |
| accountant, and | | | | |
| financial planner so as | | | | |
| to maximize his/her | | | | |
| overall financial | | | | |
| security. | | | | |
| 21. Help your parent | Level of | Completed | Level of | If No, when |
| to maximize the | Importance | Yes/No | Satisfaction | do you plan |
| advantages of the | (1-2-3-4- | | (1-2-3-4-5) | to complete |
| Internet with a secure | 5) | | | the task? |
| home-computer | N/A | | | 1-3-6-9- |
| system. | | | | 12+ |
| | | | | Months or |
| | | | | Never |
| | | | | N/A |
| 22. Review your | Level of | Completed | Level of | If No, when |
| parent's credit history. | Importance | Yes/No | Satisfaction | do you plan |
| If applicable, make | (1-2-3-4- | | (1-2-3-4-5) | to complete |
| sure your mother has | 5) | | | the task? |
| access to joint or | N/A | | | 1-3-6-9- |
| separate credit, and | | | | 12+ |
| make sure that your | | | | Months or |
| parent has taken | | | | Never |
| safety precautions to | | | | N/A |
| prevent theft and | | | | |
| scams (computer, mail | | | | |
| & phone) targeted at | | | | |
| older people. | | | | |
| 23. Determine the full | Level of | Completed | Level of | If No, when |
| extent of your parent's | Importance | Yes/No | Satisfaction | do you plan |
| health, life, & | (1-2-3-4- | | (1-2-3-4-5) | to complete |
| property insurance | 5) | | | the task? |
| coverage (to include | N/A | | | 1-3-6-9- |
| Medicare and | | | | 12+ |
| Medicaid); check for | | | | Months or |
| cost saving strategies; | | | | Never |
| and help your parent | | | | N/A |
| utilize an insurance | | | | |
| organizer to simplify | | | | |
| filing and maximize | | | | |
| his/her claims. | | | | |
| 24. Investigate the | Level of | Completed | Level of | If No, when |
| cost and financing of | Importance | Yes/No | Satisfaction | do you plan |
| relevant long term | (1-2-3-4- | | (1-2-3-4-5) | to complete |
| care scenarios (e.g., | 5) | | | the task? |
| assisted living, | N/A | | | 1-3-6-9- |
| nursing home, aging | | | | 12+ |
| in place facilities, | | | | Months or |
| retirement centers, | | | | Never |
| etc.) taking into | | | | N/A |
| account the possibility | | | | |
| of your parent current | | | | |
| and projected health | | | | |
| care status and the | | | | |
| likelihood that your | | | | |
| parent may have to | | | | |
| move more than once; | | | | |
| and enlist the advice | | | | |
| of your parent's | | | | |
| attorney, accountant, | | | | |
| and financial planner, | | | | |
| consider the | | | | |
| recommendations of | | | | |
| your parent's | | | | |
| treatment team, | | | | |
| particularly his/her | | | | |
| primary care | | | | |
| physician; and seek to | | | | |
| minimize moves while | | | | |
| maximizing his/her | | | | |
| health, dignity, and | | | | |
| access to family and | | | | |
| friends. | | | | |
| 25. Assist your parent | Level of | Completed | Level of | If No, when |
| in the completion of a | Importance | Yes/No | Satisfaction | do you plan |
| preferred possession | (1-2-3-4- | | (1-2-3-4-5) | to complete |
| list, so that he/she can | 5) | | | the task? |
| minimize future | N/A | | | 1-3-6-9- |
| family conflict over | | | | 12+ |
| ‘who’ gets ‘what’ | | | | Months or |
| from the estate (highly | | | | Never |
| valued furniture, | | | | N/A |
| heirlooms, other | | | | |
| family valuables); and | | | | |
| help him/her to | | | | |
| consider incorporating | | | | |
| the document into | | | | |
| his/her Will. | | | | |
| 26. Insure that all | Level of | Completed | Level of | If No, when |
| legal, financial, and | Importance | Yes/No | Satisfaction | do you plan |
| insurance plans are | (1-2-3-4- | | (1-2-3-4-5 | to complete |
| coordinated with those | 5) | | | the task? |
| of your parent's | N/A | | | 1-3-6-9- |
| partner to the fullest | | | | 12+ |
| extent possible. | | | | Months or |
| | | | | Never |
| | | | | N/A |
| 27. Consider whether | Level of | Completed | Level of | If No, when |
| there may be a future | Importance | Yes/No | Satisfaction | do you plan |
| need for public | (1-2-3-4- | | (1-2-3-4-5 | to complete |
| benefits, such as | 5) | | | the task? |
| Medicaid, SSI or other | N/A | | | 1-3-6-9- |
| income-based benefits | | | | 12+ |
| programs so that | | | | Months or |
| planning can take | | | | Never |
| place to insure the | | | | N/A |
| disposition of assets | | | | |
| and to insurance | | | | |
| compliance with | | | | |
| program regulations. | | | | |
| 28. Review legal | Level of | Completed | Level of | If No, when |
| ownership status of | Importance | Yes/No | Satisfaction | do you plan |
| real property, | (1-2-3-4- | | (1-2-3-4-5 | to complete |
| accounts and other | 5) | | | the task? |
| titled property of both | N/A | | | 1-3-6-9- |
| a tangible and | | | | 12+ |
| intangible nature to | | | | Months or |
| insure that both | | | | Never |
| present and future | | | | N/A |
| ownership and control | | | | |
| of the property | | | | |
| complies with client | | | | |
| wished. | | | | |
| 29. Review plans for | Level of | Completed | Level of | If No, when |
| the management and | Importance | Yes/No | Satisfaction | do you plan |
| maintenance of real | (1-2-3-4- | | (1-2-3-4-5 | to complete |
| property. | 5) | | | the task? |
| | N/A | | | 1-3-6-9- |
| | | | | 12+ |
| | | | | Months or |
| | | | | Never |
| | | | | N/A |
| 30. Schedule periodic | Level of | Completed | Level of | If No, when |
| review of health care | Importance | Yes/No | Satisfaction | do you plan |
| coverage to insure | (1-2-3-4- | | (1-2-3-4-5 | to complete |
| maximum coverage at | 5) | | | the task? |
| most economical cost, | N/A | | | 1-3-6-9- |
| including the | | | | 12+ |
| coordination of | | | | Months or |
| private insurance, | | | | Never |
| Medicare parts A, B | | | | N/A |
| and D, Medigap | | | | |
| coverage, and any | | | | |
| supplemental | | | | |
| insurance. | | | | |
| FAMILY TASKS | Level of | Completed | Satisfaction | Plans to |
| | Importance | | | Complete |
| 31. Together with | Level of | Completed | Level of | If No, when |
| your spouse (if | Importance | Yes/No | Satisfaction | do you plan |
| applicable), clarify | (1-2-3-4- | | (1-2-3-4-5) | to complete |
| your own values about | 5) | | | the task? |
| where ‘parent care’ | N/A | | | 1-3-6-9- |
| fits with your other | | | | 12+ |
| life responsibilities, | | | | Months or |
| and consider assuming | | | | Never |
| a primary or | | | | N/A |
| secondary care giving | | | | |
| role. | | | | |
| 32. Develop a | Level of | Completed | Level of | If No, when |
| sensitive, respectful | Importance | Yes/No | Satisfaction | do you plan |
| strategy for addressing | (1-2-3-4- | | (1-2-3-4-5 | to complete |
| a parent unwilling to | 5) | | | the task? |
| discuss his/her future | N/A | | | 1-3-6-9- |
| plans. | | | | 12+ |
| | | | | Months or |
| | | | | Never |
| | | | | N/A |
| 33. Organize a family | Level of | Completed | Level of | If No, when |
| meeting to develop an | Importance | Yes/No | Satisfaction | do you plan |
| initial plan about how | (1-2-3-4- | | (1-2-3-4-5) | to complete |
| each person can be | 5) | | | the task? |
| involved and of | N/A | | | 1-3-6-9- |
| assistance in caring | | | | 12+ |
| for your parent. | | | | Months or |
| | | | | Never |
| | | | | N/A |
| 34. Assist your parent | Level of | Completed | Level of | If No, when |
| in completing a | Importance | Yes/No | Satisfaction | do you plan |
| comprehensive, | (1-2-3-4- | | (1-2-3-4-5) | to complete |
| written and | 5) | | | the task? |
| computerized version | N/A | | | 1-3-6-9- |
| of his/her elder care | | | | 12+ |
| plan that could be | | | | Months or |
| made available to care | | | | Never |
| givers and members | | | | N/A |
| of your parent's | | | | |
| treatment team. | | | | |
| 35. Develop specific | Level of | Completed | Level of | If No, when |
| strategies for | Importance | Yes/No | Satisfaction | do you plan |
| responding to crises | (1-2-3-4- | | (1-2-3-4-5) | to complete |
| (e.g., health event, | 5) | | | the task? |
| break-in, and scams, | N/A | | | 1-3-6-9- |
| natural and human | | | | 12+ |
| disasters). | | | | Months or |
| | | | | Never |
| | | | | N/A |
| 36. Identify evaluation | Level of | Completed | Level of | If No, when |
| criteria for employing | Importance | Yes/No | Satisfaction | do you plan |
| all professional care | (1-2-3-4- | | (1-2-3-4-5) | to complete |
| givers, home care | 5) | | | the task? |
| workers, and other | N/A | | | 1-3-6-9- |
| employed caregivers | | | | 12+ |
| who might work with | | | | Months or |
| your parent(s). | | | | Never |
| | | | | N/A |
| 37. Develop specific | Level of | Completed | Level of | If No, when |
| strategies for ‘taking | Importance | Yes/No | Satisfaction | do you plan |
| care’ of your own | (1-2-3-4- | | (1-2-3-4-5) | to complete |
| health and well-being | 5) | | | the task? |
| while caring for your | N/A | | | 1-3-6-9- |
| parent. | | | | 12+ |
| | | | | Months or |
| | | | | Never |
| | | | | N/A |
| 38. Assess the quality | Level of | Completed | Level of | If No, when |
| of care in long term | Importance | Yes/No | Satisfaction | do you plan |
| facilities relevant to | (1-2-3-4- | | (1-2-3-4-5) | to complete |
| your parent (E.g., | 5) | | | the task? |
| nursing homes, | N/A | | | 1-3-6-9- |
| assisted living | | | | 12+ |
| facilities, dementia | | | | Months or |
| care unites, aging in | | | | Never |
| place facilities). | | | | N/A |
| 39. Consider how a | Level of | Completed | Level of | If No, when |
| “pet” can contribute to | Importance | Yes/No | Satisfaction | do you plan |
| your parent's well | (1-2-3-4- | | (1-2-3-4-5) | to complete |
| being. | 5) | | | the task? |
| | N/A | | | 1-3-6-9- |
| | | | | 12+ |
| | | | | Months or |
| | | | | Never |
| | | | | N/A |
| 40. Know what to | Level of | Completed | Level of | If No, when |
| look for regarding | Importance | Yes/No | Satisfaction | do you plan |
| changes in your | (1-2-3-4- | | (1-2-3-4-5) | to complete |
| parent's health that | 5) | | | the task? |
| might indicate when | N/A | | | 1-3-6-9- |
| your parent(s) can no | | | | 12+ |
| longer live | | | | Months or |
| independently, and | | | | Never |
| refer your parent for a | | | | N/A |
| medical evaluation | | | | |
| based upon this | | | | |
| information so that an | | | | |
| informed decision can | | | | |
| be made about where | | | | |
| your parent should | | | | |
| live. | | | | |
| SPIRITUAL- | Level of | Completed | Satisfaction | Plans to |
| EMOTIONAL | Importance | | | Complete |
| TASKS | | | | |
| 41. Learn to rely on | Level of | Completed | Level of | If No, when |
| your relationship with | Importance | Yes/No | Satisfaction | do you plan |
| God in lovingly | (1-2-3-4- | | (1-2-3-4-5) | to complete |
| meeting your | 5) | | | the task? |
| caregiving duties and | N/A | | | 1-3-6-9- |
| responsibilities. | | | | 12+ |
| | | | | Months or |
| | | | | Never |
| | | | | N/A |
| 42. Take time to | Level of | Completed | Level of | If No, when |
| understand and be | Importance | Yes/No | Satisfaction | do you plan |
| sensitive to your | (1-2-3-4- | | (1-2-3-4- | to complete |
| parent's spirituality | 5) | | 5) | the task? |
| and religiosity or lack | N/A | | | 1-3-6-9- |
| thereof. | | | | 12+ |
| | | | | Months or |
| | | | | Never |
| | | | | N/A |
| 43. Make peace with | Level of | Completed | Level of | If No, when |
| your parent regarding | Importance | Yes/No | Satisfaction | do you plan |
| his/her religious and | (1-2-3-4- | | (1-2-3-4-5) | to complete |
| spiritual beliefs. | 5) | | | the task? |
| | N/A | | | 1-3-6-9- |
| | | | | 12+ |
| | | | | Months or |
| | | | | Never |
| | | | | N/A |
| 44. Make provisions | Level of | Completed | Level of | If No, when |
| for capturing your | Importance | Yes/No | Satisfaction | do you plan |
| parent's religious and | (1-2-3-4- | | (1-2-3-4-5) | to complete |
| personal life story. | 5) | | | the task? |
| | N/A | | | 1-3-6-9- |
| | | | | 12+ |
| | | | | Months or |
| | | | | Never |
| | | | | N/A |
| 45. Create a list of | Level of | Completed | Level of | If No, when |
| local religious | Importance | Yes/No | Satisfaction | do you plan |
| programs that could | (1-2-3-4- | | (1-2-3-4-5) | to complete |
| enhance your parent's | 5) | | | the task? |
| overall health and | N/A | | | 1-3-6-9- |
| welfare, and help your | | | | 12+ |
| parent to participate | | | | Months or |
| regularly in programs | | | | Never |
| of his/her choice. | | | | N/A |
| 46. Help your parent | Level of | Completed | Level of | If No, when |
| to create a list of | Importance | Yes/No | Satisfaction | do you plan |
| religiously motivated | (1-2-3-4- | | (1-2-3-4-5) | to complete |
| opportunities for | 5) | | | the task? |
| service, and assist | N/A | | | 1-3-6-9- |
| your parent in | | | | 12+ |
| identifying specific | | | | Months or |
| ways that he or she | | | | Never |
| could serve those in | | | | N/A |
| need. | | | | |
| 47. If you and your | Level of | Completed | Level of | If No, when |
| parent are spiritually | Importance | Yes/No | Satisfaction | do you plan |
| compatible, develop | (1-2-3-4- | | (1-2-3-4-5) | to complete |
| the habit of praying | 5) | | | the task? |
| together about mutual | N/A | | | 1-3-6-9- |
| needs. | | | | 12+ |
| | | | | Months or |
| | | | | Never |
| | | | | N/A |
| 48. Learn about the | Level of | Completed | Level of | If No, when |
| religious aspects of | Importance | Yes/No | Satisfaction | do you plan |
| your parent's funeral | (1-2-3-4- | | (1-2-3-4-5) | to complete |
| wishes and develop a | 5) | | | the task? |
| specific end of life | N/A | | | 1-3-6-9- |
| plan that respects | | | | 12+ |
| those wishes. | | | | Months or |
| | | | | Never |
| | | | | N/A |
| 49. Develop a reliable | Level of | Completed | Level of | If No, when |
| contact with at least | Importance | Yes/No | Satisfaction | do you plan |
| one member of your | (1-2-3-4- | | (1-2-3-4-5) | to complete |
| parent's faith | 5) | | | the task? |
| community and | N/A | | | 1-3-6-9- |
| cultivate specific ways | | | | 12+ |
| your parent's faith | | | | Months or |
| based community can | | | | Never |
| be involved in your | | | | N/A |
| parent's elder care | | | | |
| plan. | | | | |

Sample demographics:

```
Please provide your parent's: area code   & zip code
Does your employer have an elder care
program?  Yes   No   N/A
How would you describe your parent's religious affiliation?
      Observant Jew/Orthodox Judaism/Conservative Jew
      Reformed Jew
      Roman Catholic
      Eastern Orthodox
      Assemblies of God (Pentecostal)
      Baptist (Over 27 different groups)
      Christian Church (Disciples of Christ)
      Church of the Brethren
      Church of the Nazarene
      Episcopal (Anglican)
      Lutheran (10 different types)
      Mennonite (12 Different types)
      Methodist (over 20 different types)
      Presbyterian (10 Different types)
      Quaker (Friends)
      Salvation Army
      Seventh-Day Adventist
      United Church of Christ
      Islam
      American Muslim Mission
      Christian Science
      Jehovah's Witnesses
      The church of Jesus Christ of Latter-Day Saints
      Unitarian Universalist
      Confucianism
      Buddhism
      HinduismSilhism
      Taoism
      Methodist
      Lutheran
      Catholic
      Jewish
      Buddhist
      Islamic
      Other (specify)
How many miles do you live from your parent?
```

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A computer implemented method for generating a care plan, comprising:
a. presenting a user with a plurality of domains;
b. receiving a selection of one of the plurality of domains;
c. presenting the user with a plurality of questions associated with the selected domain;
d. receiving an answer to each of the plurality of questions;
e. identifying, based on the received answers, a plurality of tasks and a priority associated with each of the plurality of tasks; and
f. presenting a prioritized listing of identified tasks as a care plan to the user.

2. The method of claim 1, wherein the plurality of domains represents a full range of caregiving tasks.

3. The method of claim 1, wherein the plurality of domains comprises at least one of a spiritual/emotional domain, a medical domain, a family/social relations domain, and a legal/financial/insurance domain.

4. The method of claim 1, wherein identifying, based on the received answers, a plurality of tasks and a priority associated with each of the plurality of tasks comprises:
determining if a task is important to the user;
determining if the task has been completed;
determining a level of user satisfaction with the completed task; and
prioritizing the task according to a stage of change based on the importance to the user, the completion of the task, and the level of user satisfaction with the completed task.

5. The method of claim 4, wherein if the task is important to the user, if the task has been completed, and if the task has been completed to the satisfaction of the user, the task is identified as a completed task stage of change.

6. The method of claim 4, wherein if the task is important to the user, if the task has been completed, and if the task has not been completed to the satisfaction of the user, the task is identified as an action stage of change task.

7. The method of claim 4, wherein if the task is not important to the user, if the task has been completed, and if the task has not been completed to the satisfaction of the user, the task is identified as a pre-contemplation stage of change task.

8. The method of claim 4, wherein if the task is not important to the user, if the task has been completed, and if the task has been completed to the satisfaction of the user, the task is identified as a completed task stage of change.

9. The method of claim 4, wherein if the task is not important to the user, if the task has been completed, and if the task has not been completed to the satisfaction of the user, the task is identified as a contemplation stage of change task.

10. The method of claim 1, wherein identifying, based on the received answers, a plurality of tasks and a priority associated with each of the plurality of tasks comprises:
determining if a task is important to the user;
determining if the task has been completed; and
determining a timeframe in which to complete the task.

11. The method of claim 10, wherein if the task is important to the user and if the task has not been completed, the task is identified as an action stage of change task if the timeframe is less than a predetermined amount or the task is identified as a preparation for stage of change task if the timeframe is greater than the predetermined amount.

12. The method of claim 1, wherein identifying, based on the received answers, a plurality of tasks and a priority associated with each of the plurality of tasks comprises:
determining if a task is important to the user; and
determining if the task has been completed, wherein if the task is not important to the user and has not been completed, the task is identified as a contemplation stage of change task.

13. The method of claim 1, further comprising providing an information package to the user based on the care plan.

14. The method of claim 1, further comprising repeating steps a-f when a life condition changes.

15. The method of claim 1, further comprising presenting a suggested action and an information package to complete at least one of the plurality of identified tasks.

16. A computer implemented method for generating a care plan, comprising:
retrieving a previously generated care plan having a prioritized task;
presenting the previously generated care plan to a user;
querying the user as to a completion status of the prioritized task;
receiving a response to the query; and
updating the previously generated care plan according to the response.

17. The method of claim 16, wherein the previously generated care plan represents a prioritized task identified based on responses to queries presented to the user associated with a domain and identifying, based on the responses, a prioritized task.

18. The method of claim 17, wherein the domain is at least one of a spiritual/emotional domain, a medical domain, a family/social relations domain, and a legal/financial/insurance domain.

19. The method of claim 18, further comprising providing an information package to the user based on the care plan.

20. A computer readable medium having computer executable instructions embodied thereon for generating a care plan, comprising:
presenting a user with a plurality of domains;
receiving a selection of one of the plurality of domains;
presenting the user with a plurality of questions associated with the selected domain;
receiving an answer to each of the plurality of questions;
identifying, based on the received answers, a plurality of tasks and a priority associated with each of the plurality of tasks; and
presenting a prioritized listing of identified tasks as a care plan to the user.
